(19) United States
(12) Patent Application Publication
(10) Pub. No.: US 2026/0113656 A1
(43) Pub. Date: Apr. 23, 2026

(54) TECHNIQUES FOR NOTIFYING PACKET DATA UNIT SET BASED QUALITY OF SERVICE REPORTS

(71) Applicant: QUALCOMM Incorporated, San Diego, CA (US)

(72) Inventors: Mickael MONDET, Louannec (FR); Prasada Veera Reddy KADIRI, San Diego, CA (US); Hyun Yong LEE, San Diego, CA (US); Diana MAAMARI, San Diego, CA (US); Sebastian SPEICHER, Wallisellen (CH)

(21) Appl. No.: 18/920,690

(22) Filed: Oct. 18, 2024

(51) Int. Cl. H04W 28/02

(52) U.S. Cl. CPC H04W 28/0268; H04W 28/0252

(57) ABSTRACT

Methods, systems, and devices for wireless communications are described. A first radio access network (RAN) node may receive, from a second node, a message that configures the first RAN node to transmit a quality of service report for a data traffic flow that includes packet data unit (PDU) sets. The quality of service report including quality of service information on a per PDU set basis. Further, the first RAN node may then transmit a quality of service notification for the data traffic flow to the second node based on a capability of the first RAN node to report quality of service information on a per PDU set basis in accordance with the message. Additionally, a user equipment (UE) may request to receive a data traffic flow that includes PDU sets and receive the PDU sets based on a of service being satisfied on a per PDU set basis.

### FIELD OF DISCLOSURE

The present disclosure, for example, relates to wireless communication systems, more particularly to techniques for notifying packet data unit (PDU) set based quality of service reports.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a first radio access network (RAN) node is described. The method may include receiving, from a second node, a first message that configures the first RAN node to transmit a quality of service report for at least one data traffic flow that includes one or more packet data unit (PDU) sets, where the quality of service report includes quality of service information on a per PDU set basis and transmitting a quality of service notification for the at least one data traffic flow to the second node, where the quality of service notification is based on a capability of the first RAN node to report quality of service on a per PDU set basis in accordance with the first message.

A first RAN node for wireless communications is described. The first RAN node may include one or more memories storing processor executable code, and one or more processors coupled with the one or more memories. The one or more processors may individually or collectively be operable to execute the code to cause the first RAN node to receive, from a second node, a first message that configures the first RAN node to transmit a quality of service report for at least one data traffic flow that includes one or more PDU sets, where the quality of service report includes quality of service information on a per PDU set basis and transmit a quality of service notification for the at least one data traffic flow to the second node, where the quality of service notification is based on a capability of the first RAN node to report quality of service on a per PDU set basis in accordance with the first message.

Another first RAN node for wireless communications is described. The first RAN node may include means for receiving, from a second node, a first message that configures the first RAN node to transmit a quality of service report for at least one data traffic flow that includes one or more PDU sets, where the quality of service report includes quality of service information on a per PDU set basis and means for transmitting a quality of service notification for the at least one data traffic flow to the second node, where the quality of service notification is based on a capability of the first RAN node to report quality of service on a per PDU set basis in accordance with the first message.

A non-transitory computer-readable medium storing code for wireless communications is described. The code may include instructions executable by one or more processors to receive, from a second node, a first message that configures the first RAN node to transmit a quality of service report for at least one data traffic flow that includes one or more PDU sets, where the quality of service report includes quality of service information on a per PDU set basis and transmit a quality of service notification for the at least one data traffic flow to the second node, where the quality of service notification is based on a capability of the first RAN node to report quality of service on a per PDU set basis in accordance with the first message.

Some examples of the method, first RAN nodes, and non-transitory computer-readable medium described herein may further include operations, features, means, or instructions for transmitting, to the second node, an indication of the capability of the first RAN node to report the quality of service on a per PDU set basis, the indication of the capability being transmitted in response to reception of the first message.

Some examples of the method, first RAN nodes, and non-transitory computer-readable medium described herein may further include operations, features, means, or instructions for receiving, from the second node and in response to transmission of the indication of the capability of the first RAN node, a request to transmit the quality of service notification for the at least one data traffic flow on a per PDU set basis in accordance with the capability of the first RAN node, where transmission of the quality of service notification may be based on reception of the request.

In some examples of the method, first RAN nodes, and non-transitory computer-readable medium described herein, the indication of the capability of the first RAN node to report the quality of service on a per PDU set basis may be transmitted via an information element on an interface between the first RAN node and the second node.

In some examples of the method, first RAN nodes, and non-transitory computer-readable medium described herein, transmitting the quality of service notification may include operations, features, means, or instructions for transmitting the quality of service notification to the second node in response to reception of the first message, where transmission of the quality of service notification may be based on the capability of the first RAN node.

In some examples of the method, first RAN nodes, and non-transitory computer-readable medium described herein, the second node may be an access and mobility function and the method, apparatuses, and non-transitory computer-readable medium may include further operations, features, means, or instructions for receiving, from the second node, the first message via one or more first messages on an interface between the first RAN node and the second node and transmitting, to the second node, an indication of the capability of the first RAN node via one or more second messages on the interface between the first RAN node and the second node.

Some examples of the method, first RAN nodes, and non-transitory computer-readable medium described herein may further include operations, features, means, or instructions for receiving, from the second node, an indication of one or more additional quality of service parameters that may be associated with PDU sets via the one or more first messages on the interface between the first RAN node and the second node.

In some examples of the method, first RAN nodes, and non-transitory computer-readable medium described herein, the one or more first messages include a PDU session resource setup request message, a PDU session modification request message, a path switch request acknowledgment message, or any combination thereof and the one or more second messages include a PDU session resource setup response message, a PDU session modification response message, a path switch request message, or any combination thereof.

In some examples of the method, first RAN nodes, and non-transitory computer-readable medium described herein, the first message may be associated with the at least one data traffic flow and the indication of the capability of the first RAN node may be associated with a quality of service flow associated with the at least one data traffic flow, a PDU session, or both.

In some examples of the method, first RAN nodes, and non-transitory computer-readable medium described herein, the first RAN node may be a distributed unit of a first network entity and the second node may be a centralized unit of the first network entity and the method, apparatuses, and non-transitory computer-readable medium may include further operations, features, means, or instructions for receiving, from the second node, the first message via one or more first messages on an interface between the first RAN node and the second node and transmitting, to the second node, an indication of the capability of the first RAN node via one or more second messages on the interface between the first RAN node and the second node.

Some examples of the method, first RAN nodes, and non-transitory computer-readable medium described herein may further include operations, features, means, or instructions for receiving, from the second node, an indication of one or more additional quality of service parameters that may be associated with PDU sets via the one or more first messages on the interface between the first RAN node and the second node.

In some examples of the method, first RAN nodes, and non-transitory computer-readable medium described herein, the one or more first messages include a context setup request message, a context modification message, or a combination thereof and the one or more second messages include a context setup response message, a context modification response message, or a combination thereof.

In some examples of the method, first RAN nodes, and non-transitory computer-readable medium described herein, the first message may be associated with a quality of service flow associated with the at least one data traffic flow and the indication of the capability of the first RAN node may be associated with a user equipment (UE) context.

In some examples of the method, first RAN nodes, and non-transitory computer-readable medium described herein, the first RAN node may be a first network entity and the second node may be a second network entity and the method, apparatuses, and non-transitory computer-readable medium may include further operations, features, means, or instructions for receiving, from the second node, the first message via one or more first messages on an interface between the first RAN node and the second node and transmitting, to the second node, an indication of the capability of the first RAN node via one or more second messages on the interface between the first RAN node and the second node.

Some examples of the method, first RAN nodes, and non-transitory computer-readable medium described herein may further include operations, features, means, or instructions for receiving, from the second node, an indication of one or more additional quality of service parameters that may be associated with PDU sets via the one or more first messages on the interface between the first RAN node and the second node.

In some examples of the method, first RAN nodes, and non-transitory computer-readable medium described herein, the one or more first messages include a handover request message, an addition request message, a modification request message, or a combination thereof and the one or more second messages include an addition request acknowledge message, a modification request acknowledge message, or a combination thereof.

In some examples of the method, first RAN nodes, and non-transitory computer-readable medium described herein, the first RAN node may be a centralized unit of a first network entity that may be associated with a user plane and the second node may be the centralized unit of the first network entity that may be associated with a control plane and the method, apparatuses, and non-transitory computer-readable medium may include further operations, features, means, or instructions for receiving, from the second node, an indication of one or more additional quality of service parameters that may be associated with PDU sets via one or more first messages on an interface between the first RAN node and the second node.

In some examples of the method, first RAN nodes, and non-transitory computer-readable medium described herein, the one or more first messages include a bearer context setup request message, a bearer context modification request message, or a combination thereof.

In some examples of the method, first RAN nodes, and non-transitory computer-readable medium described herein, the first message may be transmitted via an information element on an interface between the first RAN node and the second node and a presence of the information element indicates a request for the quality of service notification that may be on a PDU set basis.

Some examples of the method, first RAN nodes, and non-transitory computer-readable medium described herein may further include operations, features, means, or instructions for receiving, from the second node, an indication of one or more additional quality of service parameters that may be associated with PDU sets via an information element on an interface between the first RAN node and the second node.

In some examples of the method, first RAN nodes, and non-transitory computer-readable medium described herein, the one or more additional quality of service parameters includes a PDU set packet delay budget parameter, a PDU set error rate, or both.

In some examples of the method, first RAN nodes, and non-transitory computer-readable medium described herein, the indication of the one or more additional quality of service parameters associated with PDU sets may be indicated via a set of indexes associated with one or more quality of service parameters that may be associated with PDUs of PDU sets.

In some examples of the method, first RAN nodes, and non-transitory computer-readable medium described herein, an indication of one or more quality of service parameters associated with PDUs of PDU sets may be indicated via a first subset of indexes of a set of indexes and the indication of the one or more additional quality of service parameters associated with PDU sets may be indicated via a second subset of indexes of the set of indexes that may be subsequent to the first subset of indexes.

In some examples of the method, first RAN nodes, and non-transitory computer-readable medium described herein, an indication of one or more quality of service parameters associated with PDUs of PDU sets may be indicated via a first set of indexes and the indication of the one or more additional quality of service parameters associated with PDU sets may be indicated via a second set of indexes that may be different from the first set of indexes.

A method for wireless communications by a first UE is described. The method may include transmitting a request to receive a data traffic flow, where the data traffic flow includes one or more PDU sets and is associated with a quality of service and receiving the one or more PDU sets based on the quality of service being satisfied, where satisfaction of the quality of service is determined on a per PDU set basis.

A first UE for wireless communications is described. The first UE may include one or more memories storing processor executable code, and one or more processors coupled with the one or more memories. The one or more processors may individually or collectively be operable to execute the code to cause the first UE to transmit a request to receive a data traffic flow, where the data traffic flow includes one or more PDU sets and is associated with a quality of service and receive the one or more PDU sets based on the quality of service being satisfied, where satisfaction of the quality of service is determined on a per PDU set basis.

Another first UE for wireless communications is described. The first UE may include means for transmitting a request to receive a data traffic flow, where the data traffic flow includes one or more PDU sets and is associated with a quality of service and means for receiving the one or more PDU sets based on the quality of service being satisfied, where satisfaction of the quality of service is determined on a per PDU set basis.

A non-transitory computer-readable medium storing code for wireless communications is described. The code may include instructions executable by one or more processors to transmit a request to receive a data traffic flow, where the data traffic flow includes one or more PDU sets and is associated with a quality of service and receive the one or more PDU sets based on the quality of service being satisfied, where satisfaction of the quality of service is determined on a per PDU set basis.

In some examples of the method, first UEs, and non-transitory computer-readable medium described herein, satisfaction of the quality of service may be based on satisfaction of one or more PDU set quality of service parameters.

In some examples of the method, first UEs, and non-transitory computer-readable medium described herein, the one or more PDU set quality of service parameters include a PDU set delay budget parameter, a PDU set error rate parameter, a PDU set integrated handling information indicator, or any combination thereof.

In some examples of the method, first UEs, and non-transitory computer-readable medium described herein, satisfaction of the quality of service may be based on one or more thresholds being satisfied based on the one or more PDU set quality of service parameters.

In some examples of the method, first UEs, and non-transitory computer-readable medium described herein, the one or more thresholds include a guaranteed bit rate threshold, a guaranteed flow bit rate threshold, a PDU set delay budget threshold, a PDU set error rate threshold, or any combination thereof.

Details of one or more implementations of the subject matter described in this disclosure are set forth in the accompanying drawings and the description below.

Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports techniques for notifying packet data unit (PDU) set based quality of service reports in accordance with one or more aspects of the present disclosure.

FIG. 2 shows an example of a network architecture that supports techniques for notifying PDU set based quality of service reports in accordance with one or more aspects of the present disclosure.

FIG. 3 shows an example of a wireless communications system that supports techniques for notifying PDU set based quality of service reports in accordance with one or more aspects of the present disclosure.

FIGS. 4 through 7 show examples of process flows that supports techniques for notifying PDU set based quality of service reports in accordance with one or more aspects of the present disclosure.

FIGS. 8 and 9 show block diagrams of devices that support techniques for notifying PDU set based quality of service reports in accordance with one or more aspects of the present disclosure.

FIG. 10 shows a block diagram of a communications manager that supports techniques for notifying PDU set based quality of service reports in accordance with one or more aspects of the present disclosure.

FIG. 11 shows a diagram of a system including a device that supports techniques for notifying PDU set based quality of service reports in accordance with one or more aspects of the present disclosure.

FIGS. 12 and 13 show block diagrams of devices that support techniques for notifying PDU set based quality of service reports in accordance with one or more aspects of the present disclosure.

FIG. 14 shows a block diagram of a communications manager that supports techniques for notifying PDU set based quality of service reports in accordance with one or more aspects of the present disclosure.

FIG. 15 shows a diagram of a system including a device that supports techniques for notifying PDU set based quality of service reports in accordance with one or more aspects of the present disclosure.

FIGS. 16 and 17 show flowcharts illustrating methods that support techniques for notifying PDU set based quality of service reports in accordance with one or more aspects of the present disclosure.

### DETAILED DESCRIPTION

In some wireless communication systems, the core network of the wireless communication system may configure a radio access network (RAN) node to transmit quality of service notifications for quality of service flows (e.g., data traffic flows or service flows). For example, a RAN node may measure the packet data units (PDUs) of a data traffic flow that includes a set of PDUs to determine whether a data traffic flow satisfies one or more quality of service parameters. Further, the RAN node may then notify the core network of whether a respective data traffic flow satisfies the quality of service parameters based on the PDU measurements. In some cases, the RAN node may also be configured with a set of additional or alternative PDU based quality of service parameters to measure (e.g., the RAN node may perform quality of service measurements on a per PDU basis). Although, in some examples, it may be more efficient and reliable for the RAN node to measure PDU sets rather than individual PDUs. For example, a data traffic flow may include one or more PDU sets that each include one or more PDUs and having the RAN node determine whether the data traffic flow satisfies the quality of service parameters based on PDU set measurements rather than PDU measurements may be relatively more efficient. However, in some cases, a RAN node may not be configured with the capability of performing PDU set measurements for determining whether a data traffic flow satisfies the quality of service parameters, or the core network may be unaware if the RAN node is capable of performing PDU set based measurement.

In accordance with the techniques of the present disclosure, a RAN node may be configured to perform PDU set based measurement to determine if a data traffic flow satisfies quality of service requirements or parameters. For example, a core network may transmit a configuration to a RAN node configuring the RAN node to transmit a quality of service report for a data traffic flow that includes quality of service information on a per PDU set basis. In response, the core network may then request for the RAN node to transmit a PDU set based quality of service notification. In some cases, if the RAN node is capable of performing PDU set based measurements, the RAN may accept the request. In some examples, the RAN node may transmit an indication of the capability of the RAN node to the core network to indicate that the RAN node is capable of supporting PDU set based quality of service notifications. Thus, the core network may be aware of the capabilities of the RAN node prior to transmitting a request for a PDU set based quality of service notification.

In some other cases, if the RAN node is uncapable of performing the PDU set based measurements, the RAN may ignore a request from the core network to transmit a PDU set based quality of service notification. Moreover, if the RAN node supports transmitting PDU set based quality of service notifications, the core network may configure the RAN node with one or more PDU set based alternative quality of service parameters for determining whether a quality of service flow satisfies the quality of service requirements. Thus, by utilizing the PDU set based measurements and PDU set based alternative quality of service parameters, in accordance with the techniques of the present disclosure, the RAN node may be capable of transmitting PDU set based quality of service notifications to the core network resulting in relatively more accurate and efficient quality of service measurements and determinations.

Aspects of the disclosure are initially described in the context of wireless communications systems. Additional aspects of the disclosure are described with reference to a wireless communications system and process flows. Aspects of the disclosure are further illustrated by and described with reference to apparatus diagrams, system diagrams, and flowcharts that relate to techniques for notifying PDU set based quality of service reports.

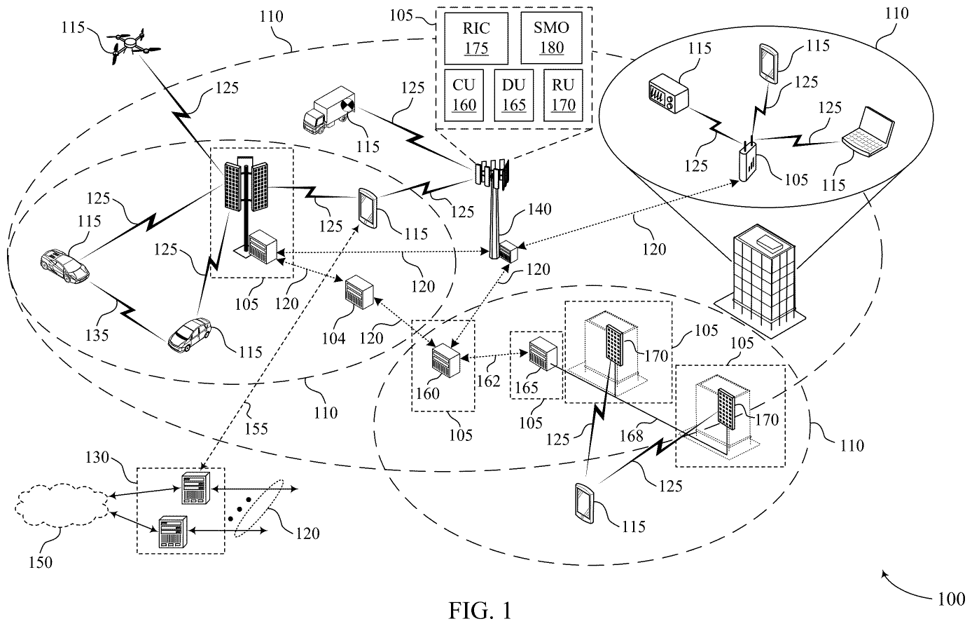

FIG. 1 shows an example of a wireless communications system 100 that supports techniques for notifying PDU set based quality of service reports in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support techniques for notifying PDU set based quality of service reports as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods.

The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some examples of the wireless communications system 100, a second node (e.g., the core network 130, an access and mobility function (AMF), a component of a network entity 105, or any combination thereof) may configure a RAN node (e.g., a network entity 105) to transmit quality of service notifications for quality of service flows (e.g., data traffic flows or service flows). For example, a RAN node may measure the PDUs of a data traffic flow that includes a set of PDUs to determine whether a data traffic flow satisfies one or more quality of service parameters. Further, the RAN node may then notify the second node of whether a respective data traffic flow satisfies the quality of service parameters based on the PDU measurements. However, in some cases, a RAN node may not be configured with the capability of performing PDU set measurements for determining whether a data traffic flow satisfies the quality of service parameters, or the second node may be unaware if the RAN node is capable of performing PDU set based measurement.

In accordance with the techniques of the present disclosure, a second node may configure a RAN node to perform PDU set based measurement to determine if a data traffic flow satisfies quality of service requirements or parameters. For example, the second node may transmit a configuration to a RAN node configuring the RAN node to transmit a quality of service report for a data traffic flow that includes quality of service information on a per PDU set basis. In response, the second node may then request for the RAN node to transmit a PDU set based quality of service notification. In some cases, if the RAN node is capable of performing PDU set based measurements, the RAN may accept the request. In some examples, the RAN node may transmit an indication of the capability of the RAN node to the second node to indicate that the RAN node is capable of supporting PDU set based quality of service notifications. Thus, the core network may be aware of the capabilities of the RAN node prior to transmitting a request for a PDU set based quality of service notification.

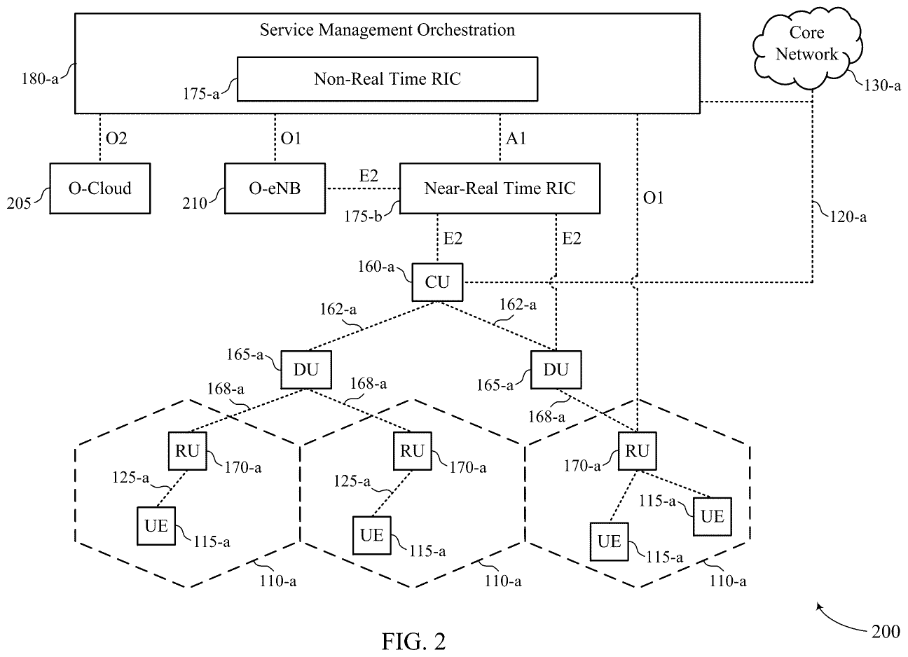

In some other cases, if the RAN node is uncapable of performing the PDU set based measurements, the RAN may ignore a request from the second node to transmit a PDU set based quality of service notification. Moreover, to support the RAN node being capable of transmitting PDU set based quality of service notifications, the second node may configure the RAN node with one or more PDU set based alternative quality of service parameters for determining whether a quality of service flow satisfies the quality of service requirements. Thus, by utilizing the PDU set based measurements and PDU set based alternative quality of service parameters, in accordance with the techniques of the present disclosure, the RAN node may be capable of transmitting PDU set based quality of service notifications to the core network resulting in relatively more accurate and efficient quality of service measurements and determinations. Further descriptions of the techniques of the present disclosure may be described elsewhere herein, such as with reference to FIGS. 2 through 7.

FIG. 2 shows an example of a network architecture 200 (e.g., a disaggregated base station architecture, a disaggregated RAN architecture) that supports techniques for notifying PDU set based quality of service reports in accordance with one or more aspects of the present disclosure. The network architecture 200 may illustrate an example for implementing one or more aspects of the wireless communications system 100. The network architecture 200 may include one or more CUs 160-a that may communicate directly with a core network 130-a via a backhaul communication link 120-a, or indirectly with the core network 130-a through one or more disaggregated network entities 105 (e.g., a Near-RT RIC 175-b via an E2 link, or a Non-RT RIC 175-a associated with an SMO 180-a (e.g., an SMO Framework), or both). A CU 160-a may communicate with one or more DUs 165-a via respective midhaul communication links 162-a (e.g., an F1 interface). The DUs 165-a may communicate with one or more RUs 170-a via respective fronthaul communication links 168-a. The RUs 170-a may be associated with respective coverage areas 110-a and may communicate with UEs 115-a via one or more communication links 125-a. In some implementations, a UE 115-a may be simultaneously served by multiple RUs 170-a.

Each of the network entities 105 of the network architecture 200 (e.g., CUs 160-a, DUs 165-a, RUs 170-a, Non-RT RICs 175-a, Near-RT RICs 175-b, SMOs 180-a, Open Clouds (O-Clouds) 205, Open eNBs (O-eNBs) 210) may include one or more interfaces or may be coupled with one or more interfaces configured to receive or transmit signals (e.g., data, information) via a wired or wireless transmission medium. Each network entity 105, or an associated processor (e.g., controller) providing instructions to an interface of the network entity 105, may be configured to communicate with one or more of the other network entities 105 via the transmission medium. For example, the network entities 105 may include a wired interface configured to receive or transmit signals over a wired transmission medium to one or more of the other network entities 105. Additionally, or alternatively, the network entities 105 may include a wireless interface, which may include a receiver, a transmitter, or transceiver (e.g., an RF transceiver) configured to receive or transmit signals, or both, over a wireless transmission medium to one or more of the other network entities 105.

In some examples, a CU 160-a may host one or more higher layer control functions. Such control functions may include RRC, PDCP, SDAP, or the like. Each control function may be implemented with an interface configured to communicate signals with other control functions hosted by the CU 160-a. A CU 160-a may be configured to handle user plane functionality (e.g., CU-UP), control plane functionality (e.g., CU-CP), or a combination thereof. In some examples, a CU 160-a may be logically split into one or more CU-UP units and one or more CU-CP units. A CU-UP unit may communicate bidirectionally with the CU-CP unit via an interface, such as an E1 interface when implemented in an O-RAN configuration. A CU 160-a may be implemented to communicate with a DU 165-a, as necessary, for network control and signaling.

A DU 165-a may correspond to a logical unit that includes one or more functions (e.g., base station functions, RAN functions) to control the operation of one or more RUs 170-a. In some examples, a DU 165-a may host, at least partially, one or more of an RLC layer, a MAC layer, and one or more aspects of a PHY layer (e.g., a high PHY layer, such as components for FEC encoding and decoding, scrambling, modulation and demodulation, or the like) depending, at least in part, on a functional split, such as those defined by the 3rd Generation Partnership Project (3GPP). In some examples, a DU 165-a may further host one or more low PHY layers. Each layer may be implemented with an interface configured to communicate signals with other layers hosted by the DU 165-a, or with control functions hosted by a CU 160-a.

In some examples, lower-layer functionality may be implemented by one or more RUs 170-a. For example, an RU 170-a, controlled by a DU 165-a, may correspond to a logical node that hosts RF processing functions, or low-PHY layer functions (e.g., performing fast Fourier transform (FFT), inverse FFT (iFFT), digital beamforming, physical random access channel (PRACH) extraction and filtering, or the like), or both, based at least in part on the functional split, such as a lower-layer functional split. In such an architecture, an RU 170-a may be implemented to handle over the air (OTA) communication with one or more UEs 115-a. In some implementations, real-time and non-real-time aspects of control and user plane communication with the RU(s) 170-a may be controlled by the corresponding DU 165-a. In some examples, such a configuration may enable a DU 165-a and a CU 160-a to be implemented in a cloud-based RAN architecture, such as a vRAN architecture.

The SMO 180-a may be configured to support RAN deployment and provisioning of non-virtualized and virtualized network entities 105. For non-virtualized network entities 105, the SMO 180-a may be configured to support the deployment of dedicated physical resources for RAN coverage requirements which may be managed via an operations and maintenance interface (e.g., an O1 interface). For virtualized network entities 105, the SMO 180-a may be configured to interact with a cloud computing platform (e.g., an O-Cloud 205) to perform network entity life cycle management (e.g., to instantiate virtualized network entities 105) via a cloud computing platform interface (e.g., an O2 interface). Such virtualized network entities 105 can include, but are not limited to, CUs 160-a, DUs 165-a, RUs 170-a, and Near-RT RICs 175-b. In some implementations, the SMO 180-a may communicate with components configured in accordance with a 4G RAN (e.g., via an O1 interface). Additionally, or alternatively, in some implementations, the SMO 180-a may communicate directly with one or more RUs 170-a via an O1 interface. The SMO 180-a also may include a Non-RT RIC 175-a configured to support functionality of the SMO 180-a.

The Non-RT RIC 175-a may be configured to include a logical function that enables non-real-time control and optimization of RAN elements and resources, Artificial Intelligence (AI) or Machine Learning (ML) workflows including model training and updates, or policy-based guidance of applications/features in the Near-RT RIC 175-b. The Non-RT RIC 175-a may be coupled to or communicate with (e.g., via an A1 interface) the Near-RT RIC 175-b. The Near-RT RIC 175-b may be configured to include a logical function that enables near-real-time control and optimization of RAN elements and resources via data collection and actions over an interface (e.g., via an E2 interface) connecting one or more CUs 160-a, one or more DUs 165-a, or both, as well as an O-eNB 210, with the Near-RT RIC 175-b.

In some examples, to generate AI/ML models to be deployed in the Near-RT RIC 175-b, the Non-RT RIC 175-a may receive parameters or external enrichment information from external servers. Such information may be utilized by the Near-RT RIC 175-b and may be received at the SMO 180-a or the Non-RT RIC 175-a from non-network data sources or from network functions. In some examples, the Non-RT RIC 175-a or the Near-RT RIC 175-b may be configured to tune RAN behavior or performance. For example, the Non-RT RIC 175-a may monitor long-term trends and patterns for performance and employ AI or ML models to perform corrective actions through the SMO 180-a (e.g., reconfiguration via O1) or via generation of RAN management policies (e.g., A1 policies).

In some examples of the network architecture 200, a second node (e.g., the core network 130-a, an AMF, a network entity 105, a CU 160 of a network entity 105, or any combination thereof) may configure a RAN node (e.g., a network entity 105, a CU 160 of a network entity 105, a DU 165 of a network entity 105, or any combination thereof) to transmit quality of service notifications for quality of service flows (e.g., data traffic flows or service flows). For example, a RAN node may measure the PDUs of a data traffic flow that includes a set of PDUs to determine whether a data traffic flow satisfies one or more quality of service parameters. Further, the RAN node may then notify the second node of whether a respective data traffic flow satisfies the quality of service parameters based on the PDU measurements. However, in some cases, a RAN node may not be configured with the capability of performing PDU set measurements for determining whether a data traffic flow satisfies the quality of service parameters, or the second node may be unaware if the RAN node is capable of performing PDU set based measurement.

In accordance with the techniques of the present disclosure, a second node may configure a RAN node to perform PDU set based measurement to determine if a data traffic flow satisfies quality of service requirements or parameters. For example, the second node may transmit a configuration to a RAN node configuring the RAN node to transmit a quality of service report for a data traffic flow that includes quality of service information on a per PDU set basis. In response, the second node may then request for the RAN node to transmit a PDU set based quality of service notification. In some cases, if the RAN node is capable of performing PDU set based measurements, the RAN may accept the request. In some examples, the RAN node may transmit an indication of the capability of the RAN node to the second node to indicate that the RAN node is capable of supporting PDU set based quality of service notifications. Thus, the core network may be aware of the capabilities of the RAN node prior to transmitting a request for a PDU set based quality of service notification.

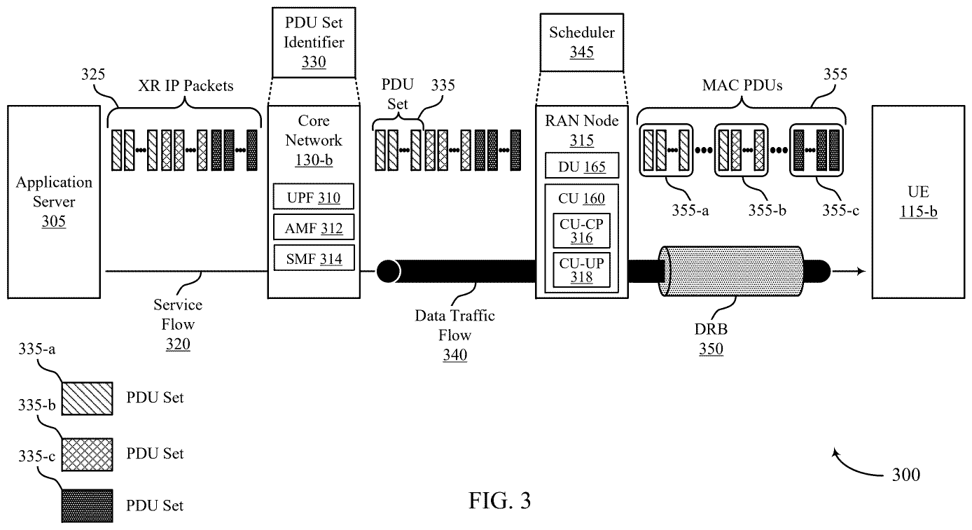

In some other cases, if the RAN node is uncapable of performing the PDU set based measurements, the RAN may ignore a request from the second node to transmit a PDU set based quality of service notification. Moreover, to support the RAN node being capable of transmitting PDU set based quality of service notifications, the second node may configure the RAN node with one or more PDU set based alternative quality of service parameters for determining whether a quality of service flow satisfies the quality of service requirements. Thus, by utilizing the PDU set based measurements and PDU set based alternative quality of service parameters, in accordance with the techniques of the present disclosure, the RAN node may be capable of transmitting PDU set based quality of service notifications to the core network resulting in relatively more accurate and efficient quality of service measurements and determinations. Further descriptions of the techniques of the present disclosure may be described elsewhere herein, such as with reference to FIGS. 3 through 7.

FIG. 3 shows an example of a wireless communications system 300 that supports techniques for notifying PDU set based quality of service reports in accordance with one or more aspects of the present disclosure. In some examples, the wireless communications system 300 may implement or be implemented by the wireless communications system 100, the network architecture 200, or both. For example, the wireless communications system 300 may include a core network 130-b, an application server 305, a RAN node 315, and a UE 115-b, which may represent examples of corresponding devices described herein with reference to FIG. 1. Further, the core network 130-b may include a user plane function 310, an AMF 312, and a session management function (SMF) 314. In some examples, the core network 130-b, the application server 305, the RAN node 315, and the UE 115-b may all communicate via one or more communication links 125. In some examples, the communication links 125 may be examples of a Uu link, a sidelink, a backhaul link, a D2D link, an uplink communication link, a downlink communication link, or some other type of communication link 125 described herein with reference to FIG. 1. Further, in some cases, the RAN node 315 may communicate with other nodes, such as a second node, via one or more interfaces (e.g., an NG interface, an Xn interface, an F1 interface, an E1 interface, or any combination thereof). Moreover, as described with reference to FIGS. 1 and 2, the RAN node 315 which may be an example of a network entity 105 may include a DU 165 and a CU 160 that includes a CU-CP 316 and a CU-UP 318.

In some examples of the wireless communications system 300, a UE 115-b may receive one or more service flows 320 from a RAN node 315. In some cases, a service flow 320 may include a set of IP packets 325 from an application server 305, the core network 130-b, or both. In some examples, the set of IP packets 325 include video frames or video slices for extended reality (XR) services and the service flow 320 may be associated with a respective XR service. XR may include virtual reality (VR), augmented reality (AR), mixed reality (MR), or any combination thereof. In some cases, XR services may be multi-modal and the set of IP packets 325 may include multiple different types of data packets.

To receive the one or more service flows 320, the UE 115-b may transmit a request to receive the one or more service flows 320. In response to the request, the application server 305 may generate the set of IP packets 325 to transmit to the user plane function 310 of the core network 130-b. Based on receiving the set of IP packets 325, the core network 130-b may use a PDU set identifier 330. In some examples, the core network 130-b may use the PDU set identifier 330 to identify one or more PDU sets 335 (e.g., a PDU set 335-a, a PDU set 335-b, and a PDU set 335-c) within the set of IP packets 325 of a service flow 320. A PDU set 335 may include one or more PDUs that carry the payload of a single unit of information generated at the application level (e.g., generated by the application server 305). For example, the PDUs may carry or indicate payloads for video frames or audio packets for an XR service (e.g., the service flow 320). In some examples, a PDU set 335 may be a set of PDUs that are associated with the same data type, the same service, the same device, or any combination thereof. For example, in some cases, for an XR service, the PDU set 335-a may be associated with video data, the PDU set 335-b may be associated with audio data, and the PDU set 335-c may be associated with text-based data (e.g., chat messages). In another example, for an XR service, the PDU set 335-a may be associated with a VR Head-Mounted Display (HMD), the PDU set 335-b may be associated with a pair of VR/AR gloves, and the PDU set 335-c may be associated with a set of VR/AR glasses. As such, each PDU set 335 may include one or more associated PDUs.

Further, the core network 130-b may generate one or more data traffic flows 340 (e.g., a quality of service flow) that includes the one or more PDU sets 335 and may transmit the data traffic flow 340 to the RAN node 315. In some examples, to transmit the one or more data traffic flows 340 to the UE 115-b, the RAN node 315 may use a scheduler 345 to schedule the transmissions of the one or more data traffic flows 340 within a data radio bearer (DRB) 350. In some examples, the RAN node 315 may use the DRB 350 to transmit data packets to the UE 115-b within the wireless communications system 300. For example, the RAN node 315 may transmit one or more MAC PDUs 355 (e.g., a MAC PDU 355-a, a MAC PDU 355-b, and a MAC PDU 355-c) to the UE 115-b via the DRB 350. In some cases, when the RAN node 315 schedules the transmission of the MAC PDUs 355 to the UE 115-b via the DRB 350, the RAN node 315 may use the scheduler 345 to determine an order of transmission of the PDUs within the PDU sets 335. For example, the UE 115-b may expect to receive the PDUs in a different order than the order that the RAN node 315 received the PDUs within the PDU sets 335 from the user plane function 310. Thus, the scheduler 345 of the RAN node 315 may reorder the PDUs into the one or more MAC PDUs 355 for transmission to the UE 115-b.

In some examples, prior to transmission of the MAC PDUs 355 to the UE 115-b, the RAN node 315 may determine whether one or more quality of service parameters for a respective data traffic flow 340 of a service flow 320 can be satisfied. For example, the RAN node 315 may implement a quality of service notification control mechanism or procedure such that the RAN node 315 is capable of reporting whether the RAN node 315 can guarantee one or more quality of service parameters (e.g., a guaranteed flow bit rate (GFBR) parameter). In some cases, the core network 130-b (e.g., the SMF 314 of the core network 130-b) may configure the RAN node 315 with a quality of service notification mechanism for measuring the guaranteed bit rate (GBR) of a respective data traffic flow 340. For example, the RAN node 315 may receive, from the core network 130-b, a PDU session resource setup request message that requests a quality of service notification for one or more data traffic flows 340. In response, for each data traffic flow 340, the RAN node 315 may determine whether the data traffic flow 340 satisfies one or more quality of service parameters that are associated with individual PDUs. For example, the RAN node 315 may measure the GFBR, a packet delay budget (PDB), and a packet error rate (PER) for each PDU of each PDU set within a respective data traffic flow 340 to determine whether the respective data traffic flow 340 satisfies the one or more PDU based quality of service parameters (e.g., a GFBR parameter, a PDB parameter, a PER parameter, or any combination thereof). In some cases, to determine if a quality of service parameter is satisfied, the RAN node 315 may determine if an associated quality of service parameter measurement satisfies a corresponding threshold (e.g., a GFBR threshold, a PDB threshold, a PER threshold, or any combination thereof).

In some cases, the RAN node 315 may determine that the RAN node 315 is unable of guarantying the GFBR. Thus, the RAN node 315 may transmit a quality of service notification to the core network 130-b indicating that the RAN node 315 is unable to guarantee the quality of service expectations of the data traffic flow 340. In some other cases, the RAN node 315 may determine that the RAN node 315 is capable of guarantying GFBR and the RAN node 315 may indicate to the core network 130-b as such within the quality of service notification for the data traffic flow 340. Based on the determinations by the RAN node 315 and receiving the quality of service notifications from the RAN node 315, the core network 130-b, the application server 305, or both may adjust accordingly to ensure that the wireless communications system 300 is reliable and efficient. For example, the core network 130-b, the application server 305, or both may perform rate adaptations to assist in satisfying the quality of service parameters for the data traffic flow 340.

In some examples, the core network 130-b may also provide the RAN node 315 with one or more alternative quality of service profiles for a data traffic flow 340 (e.g., a GBR quality of service flow) that has notification controls enabled (e.g., a data traffic flow 340 that the RAN node 315 is capable of transmitting a quality of service notification for). For example, when the RAN node 315 transmits a notification to the SMF indicating that a quality of service profile is unfulfilled (e.g., one or more quality of service parameters are unfulfilled), the RAN node 315 may also indicate whether an alternative quality of service profile is fulfilled (e.g., whether one or more alternative quality of service parameters are fulfilled). Further, when the SMF 314 of the core network 130-b configures the RAN node 315 with the capability to transmit a quality of service notification, the SMF may also configure the RAN node 315 with an alternative quality of service profile for the one or more data traffic flows 340.

Therefore, for each data traffic flow 340, the RAN node 315 may check whether a main quality of service profile is satisfied (e.g., whether a GBR, PER, PDB, or any combination thereof are satisfied) and check whether some of the alternative quality of service profiles are satisfied (e.g., whether one or more alternative quality of service parameters are satisfied). If the RAN node 315 determines that the main quality of service profile is unsatisfied, the RAN node 315 may report that the RAN node 315 is unable to guarantee the GFBR of the respective data traffic flow. Further, if one or more of the alternative quality of service profiles (e.g., one or more of the alternative quality of service parameters) are satisfied, the RAN node 315 may indicate a reference to the highest priority profile (e.g., the highest priority quality of service parameter). Moreover, when receiving a list of alternative quality of service profiles or parameters, the RAN node 315 may receive the list in an order from highest to lowest priority. Thus, the core network 130-b, the application server 305, or both, may utilize these indications to enhance the performance of the wireless communications system 300 as described herein.

To support the service flow 320 (e.g., a service flow 320 associated with XR services or XR and media (XRM) services) more efficiently, in some cases, the RAN node 315 may utilize a PDU set 335 based quality of service framework. The PDU set 335 based quality of service framework may include additional quality of service parameters such as a PDU set 335 delay budget (PSDB) parameter, a PDU set 335 error rate (PSER), a PDU set 335 integrated handling information (PSIHI) parameter, among others. In some examples, the RAN node 315 may receive the PDU set 335 quality of service parameters from the core network 130-b and thus enable the PDU set based quality of service handling by applying the PDU set 335 quality of service parameters. However, even though the core network 130-b may configure a data traffic flow 340 (e.g., a GBR quality of service flow) with PDU set 335 based quality of service parameters, the RAN node 315 may still use the PDU based quality of service parameters (e.g., PER and PDB parameters, which are based on individual PDUs), to assess and determine whether the RAN node 315 can guarantee the GFBR. Although, using quality of services parameters that are based on individual PDUs (e.g., PER and PDB parameters) rather than PDU sets 335 (e.g., PSER and PSDB parameters) may be relatively inefficient and can result in inaccurate measurements and determinations.

Additionally, or alternatively, even though the core network 130-b configures the data traffic flow 340 with a PDU set 335 based quality of service profile, the core network 130-b may be unable to provide the RAN node 315 with alternative PDU set 335 based quality of service profiles or parameters. Thus, the application function (e.g., the application server 305, the core network 130-b, or both) may be unable to receive an indication of whether the RAN node 315 can determine that an alternative PDU set 335 quality of service profile is satisfied.

Therefore, if the core network 130-b configures the data traffic flow 340 with PDU set 335 based quality of service parameters, the techniques of the present disclosure may describe the RAN node 315 being capable of receiving a request to use the PDU set 335 based quality of service parameters for quality of service notification reporting. For example, the techniques of the present disclosure may describe a first RAN node (e.g., the RAN node 315, a network entity 105, the DU 165, the CU-UP 318, or any combination thereof) receiving, from a second node (e.g., the AMF 312, the CU 160, a network entity 105, the CU-CP 316, or any combination thereof), a first message that configures the RAN node 315 to transmit a quality of service report for at least one data traffic flow 340 that includes one or more PDU sets 335. Moreover, the quality of service report may include quality of service information on a per PDU set 335 basis. Further, in some cases, the techniques of the present disclosure may describe the RAN node 315 being capable of transmitting an indication to the core network 130-b to indicate whether the RAN node 315 is capable of supporting a transmission of a quality of service notification based on the PDU set 335 quality of service parameters. Thus, based on the indication, the core network 130-b may request that the RAN node 315 transmit a PDU set 335 based quality of service notification. In response, the RAN node 315 may transmit a quality of service notification for the at least one data traffic flow 340 to the second node (e.g., the core network 130-b). Further, the quality of service notification may be based on a capability of the RAN node 315 to report quality of service information on a per PDU set 335 basis in accordance with the first message.

For example, in accordance with the techniques of the present disclosure, the RAN node 315 may transmit, to a second node an indication of a capability of the RAN node 315 to report the quality of service information on a per PDU set 335 basis. That is, the RAN node 315 may transmit a capability message to the core network 130-b indicating whether the RAN node 315 is capable of supporting PDU set 335 based quality of service notifications. Moreover, in some cases, the RAN node 315 may transmit the indication of the capability in response to receiving the first message. In such examples, if the RAN node 315 transmits a capability message indicating that the RAN node 315 is capable of supporting PDU set 335 based quality of service notifications, the core network 130-b may then request for a PDU set 335 based quality of service notification from the RAN node 315. For example, in response to transmitting the indication of the capability of the RAN node 315, the RAN node 315 may receive, from the core network 130-b, a request to transmit the quality of service notification for the at least one data traffic flow 340 on a per PDU set 335 basis in accordance with the capability of the RAN node 315. Moreover, the RAN node 315 may then transmit the quality of service notification in response to the request.

In another examples, in accordance with the techniques of the present disclosure, the RAN node 315 may refrain from transmitting a capability message indicating whether the RAN node 315 is capable of supporting PDU set 335 based quality of service notifications. For example, the core network 130-b may request for a PDU set 335 based quality of service notification regardless of the capabilities of the RAN node 315. Additionally, or alternatively, the core network 130-b may transmit the request for the quality of service notifications within the first message that configures the RAN node 315 to transmit a quality of service report that includes quality of service information on a per PDU set 335 basis. Thus, in some cases, if the RAN node 315 is capable of supporting PDU set 335 based quality of service notifications, the RAN node 315 may transmit a PDU set 335 based quality of service notification to the core network 130-b in response to receiving the first message. In some other cases, if the RAN node 315 is incapable of supporting PDU set 335 based quality of service notifications, the RAN node 315 may ignore the request indicated in the first message. Additionally, or alternatively, based on the RAN node 315 refraining from transmitting a PDU set 335 based quality of service notification, after a quantity of time (e.g., an expiration of a timer), the core network 130-b may determine that the RAN node 315 is unable to support PDU set 335 based quality of service notifications.

Further, in accordance with the techniques of the present disclosure, the core network 130-b may also provide the RAN node 315 with a list of alternative PDU set 335 based quality of service profiles that are ordered by decreasing priority. Thus, the RAN node 315 may be determining if the values of the quality of service parameters (e.g., GFBR, PSDB, PSER, or any combination thereof) match one of the alternative PDU set 335 based quality of service profiles. Moreover, in some cases, the RAN node 315 determine that a main PDU set 335 based quality of service profile is unable to be satisfied and determine that one or more of the alternative PDU set 335 based quality of service profiles are satisfied. Therefore, in accordance with the techniques of the present disclosure, the RAN node 315 may indicate the highest priority alternative PDU set 335 based quality of service profile that is satisfied within the PDU set 335 based quality of service notification.

In some examples, for PDU based alternative quality of service parameters set lists, the core network 130-b may configure the RAN node 315 with an alternative quality of service parameters set index information element to identify a set. In some cases, the alternative quality of service parameters set index information element may be included within an alternative quality of service parameters set list that may include alternative sets of quality of service parameters that the RAN node 315 can indicate as fulfilled when notification (e.g., quality of service notification) control is enabled and a data traffic flow 340 is unable to fulfill a list of requested quality of service parameters. Further, the index of the alternative quality of service parameters set index information element may have a value range of 1 to 8 (e.g., [1 . . . 8]) and the indexes may be used by the RAN node 315 to indicate that a respective alternative quality of service parameters set is fulfilled. Moreover, the index of the alternative quality of service parameters set index information element may indicate the index of the item within the alternative quality of service parameters set list information element corresponding to the alternative quality of service parameters set that a data traffic flow 340 is currently fulfilling or satisfying.

In some other examples, the RAN node 315 may determine that none of the alternative quality of service parameters sets are fulfilled and may use an alternative quality of service parameters set notify index information element. The alternative quality of service parameters set notify index information element may indicate the quality of service parameters that a respective data traffic flow 340 is capable of fulfilling. Further, the alternative quality of service parameters set notify index information element may have a value range of 0 to 8 (e.g., [0 . . . 8]). Moreover, the alternative quality of service parameters set notify index information element may indicate the index of the item within the alternative quality of service parameters set list information element corresponding to the alternative quality of service parameters set that a data traffic flow 340 is currently fulfilling or satisfying, Further, an index value of 0 may indicate that the RAN node 315 is uncapable of fulfilling even the lowest priority alternative parameters set

In some examples, in accordance with the techniques of the present disclosure, the RAN node 315 may use the same indexes for both PDU based and PDU set 335 based alternative quality of service parameters set lists. In such cases, the node receiving the message (e.g., the core network 130-b) may know whether data traffic flow 340 is configured with PDU based or PDU set 335 based alternative quality of service parameters set lists and may know that the data traffic flow 340 may be unable to carry both PDUs outside of PDU sets and PDU sets 335. Thus, the core network 130-b may identify the corresponding alternative set accordingly. Therefore, the indication of the one or more additional quality of service parameters associated with PDU sets 335 may be indicated via a set of indexes associated with one or more quality of service parameters that are associated with PDUs of PDU sets. Further, the RAN node 315 may reuse the alternative quality of service parameters set index information element and the alternative quality of service set notify index information element to identify, signal, and report alternative PDU set 335 based quality of service parameters sets.

In some other examples, in accordance with the techniques of the present disclosure, the same indexes in the alternative quality of service parameters set index information element and the alternative quality of service set notify index information element may be used with an extended range. For example, for index values [1 . . . 8] may be associated with PDU based alternative quality of service parameters sets and index values [9 . . . 16] may be associated with PDU set 335 based alternative quality of service parameters sets. Therefore, the indication of one or more quality of service parameters associated with PDUs of PDU sets 335 may be indicated via a first subset of indexes of a set of indexes and the indication of the one or more additional quality of service parameters associated with PDU sets 335 may be indicated via a second subset of indexes of the set of indexes that is subsequent to the first subset of indexes. Thus, based on receiving a quality of service notification, the core network 130-b may be capable determining whether a respective index is associated with an PDU based alternative set or an PDU set 335 based alternative set based on the value of the index even when the core network 130-b is unaware of the configuration of the RAN node 315. For example, the core network 130-b may be unaware of whether the RAN node 315 is configured to use PDU based or PDU set 335 based quality of service parameters. Moreover, in such cases, the alternative quality of service parameters set index information element and the alternative quality of service set notify index information element may be reused with extended value ranges as an indicator of a type of alternative quality of service parameters set (e.g., PDU based or PDU set 335 based).

In another example, the techniques of the present disclosure describes additional information elements with different sets of indexes being used to indicate the PDU based alternative quality of service parameters sets and the PDU set 335 based alternative quality of service parameters sets. Thus, an indication of the one or more quality of service parameters associated with PDUs of PDU sets may be indicated via a first set of indexes and the indication of the one or more additional quality of service parameters associated with PDU sets may be indicated via a second set of indexes that is different from the first set of indexes. Further, the RAN node 315 may use an alternative PDU set 335 based quality of service parameters set index information element and an alternative PDU set 335 based quality of service parameters set notify index information element to identify, signal, and report alternative PDU set 335 based quality of service parameters sets.

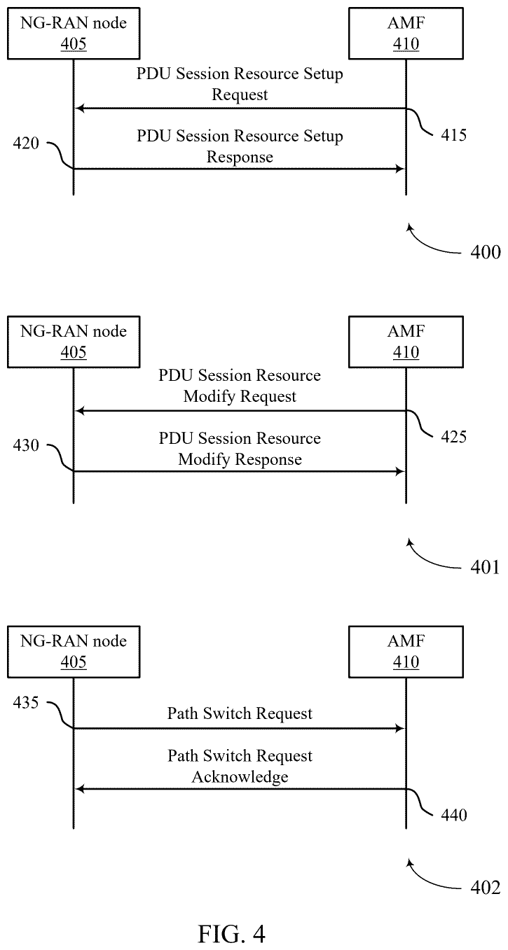

Further descriptions of the techniques of the present disclosure may be described elsewhere herein. For example, FIGS. 4 through 7 may describe the RAN node 315 receiving a first message configuring the RAN node 315 to transmit a quality of service report for at least one data traffic flow 340 that includes quality of service information on a per PDU set 335 basis. In some cases, the first message may configure the RAN node 315 to transmit a PDU set 335 based quality of service notification based on an inclusion of a PDU set 335 notification control information element. Thus, the first message may be transmitted via an information element on an interface between the RAN node 315 and a second node (e.g., the core network 130-b) and a presence of the information element may indicate a request for the quality of service notification that is on a per PDU set 335 basis. Further, FIGS. 4 through 7 may describe the RAN node 315 transmitting an indication of the capability of the RAN node 315 to report the quality of service on a per PDU set 335 basis. In some cases, the RAN node 315 may transmit the indication of the capability via a PDU set 335 based quality of service notification information element. Additionally, or alternatively, FIGS. 4 through 7 may describe the RAN node 315 receiving an indication of one or more additional quality of service parameters that are associated with PDU sets 335. For example, the RAN node 315 may receive an alternative PDU set 335 based quality of service parameters set list that includes the one or more additional quality of service parameters. Additionally, or alternatively, the RAN node 315 may receive, from a second node (e.g., the core network 130-b), an indication of the one or more additional quality of service parameters that are associated with PDU sets 335 via an information element on an interface between the RAN node 315 and the second node.

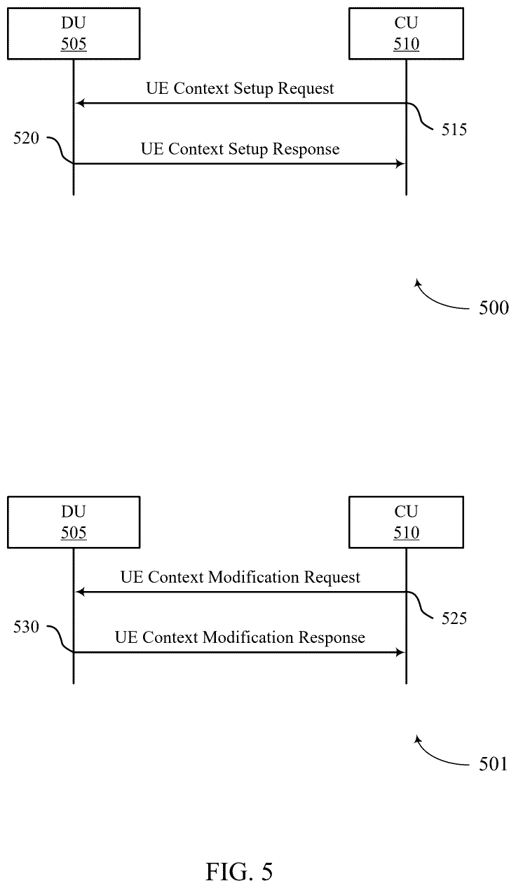

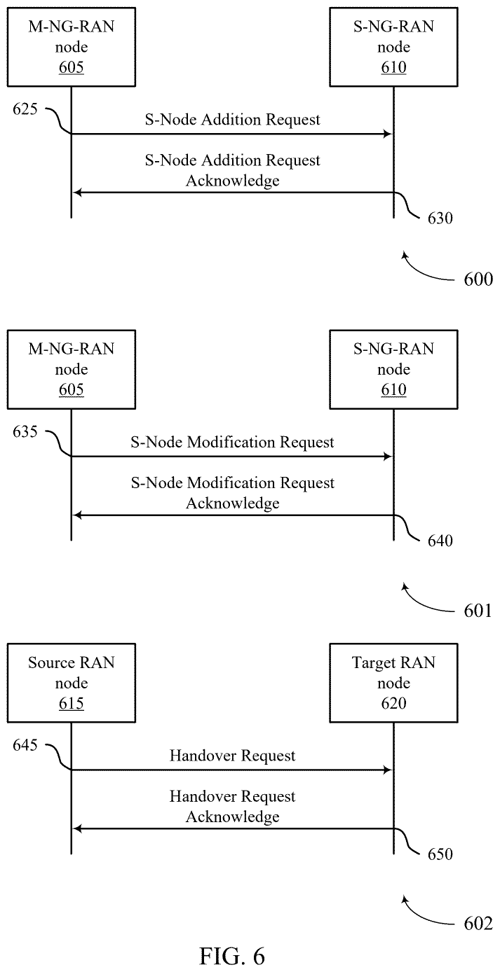

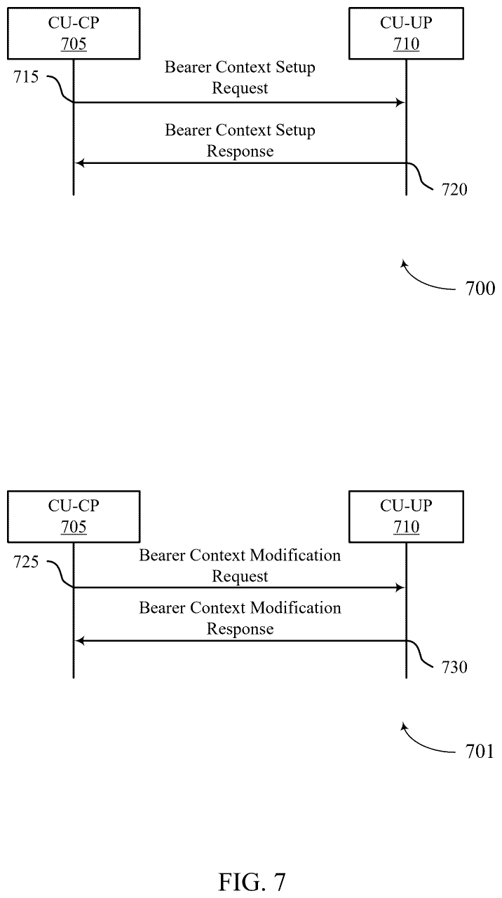

Moreover, FIG. 4 may describe such signaling in reference to an NG interface between a RAN node 315 and the AMF 312. FIG. 5 may describe the signaling in reference to an F1 interface between a CU 160 and a DU 165. FIG. 6 may describe the signaling in reference to an Xn interface between a first network entity 105 and a second network entity 105. Further, FIG. 7 may describe the signaling in reference to an E1 interface between a CU-UP 318 and a CU-CP 316.

FIG. 4 shows an example of a process flow 400, a process flow 401, and a process flow 402 that supports techniques for notifying PDU set based quality of service reports in accordance with one or more aspects of the present disclosure. In some examples, the process flow 400, the process flow 401, and the process flow 402 may implement or may be implemented by the wireless communications system 100, the network architecture 200, the wireless communications system 300, or any combination thereof. The process flow 400, the process flow 401, and the process flow 402 may include a NG-RAN node 405 and an AMF 410 which may be examples of devices or services described elsewhere herein including with reference to FIGS. 1 through 3. Further, in some examples, the NG-RAN node 405 may be referred to as a first RAN node and the AMF 410 may be referred to as a second node. Moreover, in some cases, the NG-RAN node 405 and the AMF 410 may communicate via an interface between the NG-RAN node 405 and the AMF 410. In some examples, the interface may be an NG interface that is for communications between the core network 130 of a wireless communications system (e.g., the wireless communications system 100, the network architecture 200, the wireless communications system 300, or any combination thereof) and a network entity 105.

In the following description of the process flow 400, the process flow 401, and the process flow 402, the operations may be performed by the NG-RAN node 405 and the AMF 410 in different orders or at different times. Some operations may also be left out of the process flow 400, the process flow 401, and the process flow 402, or other operations may be added. Although the process flow 400, the process flow 401, and the process flow 402 may be described as being performed by the NG-RAN node 405 and the AMF 410, some aspects of some operations may also be performed by other devices, services, or models described elsewhere herein including with reference to FIGS. 1 through 3.

In some examples, the process flow 400 may illustrate a PDU session resource setup procedure. For example, at 415, the AMF 410 may transmit a first message (e.g., a PDU session resource setup response message) to the NG-RAN node 405 requesting a PDU session resource setup. In some examples, the AMF 410 may transmit the first message as first part of the PDU session resource setup procedure. In some cases, the PDU session resource setup procedure may assign the NG-RAN node 405 with resources for one or more PDU sessions and corresponding data traffic flows. Further, the procedure may also set up corresponding DRBs for a UE 115. In response, at 420, the NG-RAN node 405 may transmit a PDU session resource setup response message to the AMF 410 as a second part of the PDU session resource setup procedure.

In some other examples, the process flow 401 may illustrate a PDU session resource modification procedure to enable configuration modifications of established PDU sessions for UEs 115. At 425, the AMF 410 may initiate the PDU session resource modification procedure by transmitting a PDU session resource modify request to the NG-RAN node 405. In response, the NG-RAN node 405 may execute a configuration modification and at 430, the NG-RAN node 405 may transmit a PDU session resource response message to the AMF 410.

In another example, the process flow 402 may illustrate a path switch request procedure to request a switch of a downlink termination point towards a different termination point. For example, at 435, the NG-RAN node 405 may transmit a path switch request message to the AMF 410 to initiate the patch switch request procedure. In response to receiving the request message, the AMF 410 may, for each associated PDU session, transfer a path switch request transfer information element to the SMF of the core network 130 associated with the respective PDU sessions. Further, at 440, after completing the path switches for at least one of the PDU session resources indicated in the path switch request message, the AMF 410 may transmit a path switch request acknowledge message to the NG-RAN node 405.

In some examples, in accordance with the techniques of the present disclosure, a first RAN node (e.g., the NG-RAN node 405) may receive, from a second node (e.g., the AMF 410) the first message, that configures the first RAN node to transmit a quality of service report for at least one data traffic flow that includes one or more PDU sets, via one or more first messages, on an interface between the first RAN node and the second node. Further, as the first RAN node may be the NG-RAN node 405 and the second node may be the AMF 410, the interface between the first RAN node and the second node may be an NG interface. Moreover, in some examples, the NG interface may be a wireless interface, a wired interface, or a combination thereof.

Further, in some examples, the NG-RAN node 405 may receive the configuration from the AMF 410 via a PDU session resource setup request message received at 425, a PDU session modification request message received at 430, a path switch request acknowledge message received at 440, or any combination thereof. In some cases, the configuration for the PDU set based quality of service notifications may be added at the quality of service flow level (e.g., the data traffic flow level) via a PDU session resource setup request transfer message, a PDU session resource modify request transfer message, a path switch request acknowledge transfer message, or any combination thereof. Moreover, the NG-RAN node 405 may receive the configuration for PDU set based quality of service notifications from the AMF 410 via such messages based on an inclusion of a PDU set notification control information element. Additionally, or alternatively, if the PDU set notification control information element is present, the NG-RAN node 405 may determine that a PDU set based quality of service notification is requested. Otherwise, if the PDU set notification control information element is absent, the NG-RAN node 405 may determine that a PDU set based quality of service notification is not requested.

In another example, the first RAN node (e.g., the NG-RAN node 405) may receive, from the second node (e.g., the AMF 410), an indication of one or more additional quality of service parameters that are associated with PDU sets (e.g., alternative PDU set based quality of service parameters) via the one or more first messages on the interface between the first RAN node and the second node. For example, the core network 130 (e.g., the second node, the AMF 410) may configure the first RAN node (e.g., the NG-RAN node 405) with an alternative PDU set based quality of service set list through the PDU session resource setup request message received at 425, the PDU session modification request message received at 430, the path switch request acknowledge message received at 440, or any combination thereof. Further, in the PDU session resource setup request message and the PDU session resource modify request message, the alternative PDU set based quality of service set list may be added to a GBR quality of service flow information element that is an NG application protocol (NGAP) information element. Moreover, in the path switch request acknowledge message, the alternative PDU set based quality of service set list may be added to a path switch request acknowledge transfer information element that is an NGAP information element. Further, in some examples, the additional quality of service parameters may include a PSDB parameter, a PSER parameter, or both. Additionally, or alternatively, an alternative quality of service parameters set index information element for the NG interface may be modified to include a current quality of service parameters set index information element within a quality of service flow list with data forwarding information element or a path switch request transfer information element, a quality of service flow add or modify response list information element within a PDU session resource modify response transfer information element, or any combination thereof. Moreover, an alternative quality of service parameters set notify index information element for the NG interface may be modified to include a current quality of service parameters set index within a PDU session resource notify transfer information element.

Further, in accordance with the techniques of the present disclosure, the first RAN node (e.g., the NG-RAN node 405) may transmit, to the second node (e.g., the AMF 410), an indication of the capability of the first RAN node (e.g., a capability to support transmitting PDU set based quality of service notifications) via one or more second messages on the interface between the first RAN node and the second node. In some cases, the NG-RAN node 405 may transmit the capability of the NG-RAN node 405 to the AMF 410 to indicate whether the NG-RAN node 405 is capable of supporting PDU set based quality of service notifications when a PDU session is setup or modified. For example, the NG-RAN node 405 may transmit the indication of the NG-RAN node 405 to the AMF 410 via the PDU session resource setup response message transmitted at 420, the PDU session resource modification response message transmitted at 430, or both. Further, the NG-RAN node 405 may also transmit the indication of the capability of the NG-RAN node 405 to the AMF 410 via the path switch request message transmitted at 435. Moreover, the NG-RAN node 405 may add that the NG-RAN node 405 is capable of supporting PDU set based quality of service notifications at a PDU session level or at a data traffic flow level (e.g., a quality of service flow level). Further, the indication of the capability of the NG-RAN node 405 to support the PDU set based quality of service notifications may be added to a PDU session resource setup response transfer information element, a PDU session resource modify response transfer information element, a path switch request transfer information element, or any combination thereof. Additionally, or alternatively, the NG-RAN node 405 may add the indication of the capability of the NG-RAN node 405 to the one or more information elements via a PDU set based quality of service notification indicator.

Further descriptions of the techniques of the present disclosure may be described elsewhere herein. For example, FIGS. 5 through 7 may describe the first RAN node receiving the first message from the second node configuring the first RAN node, the first RAN node receiving one or more additional quality of service parameters associated with PDU sets from the second node, the first RAN node transmitting an indication of the capability of the first RAN node to the second node, or any combination thereof, with respect to one or more other interfaces between the first RAN node and the second node. For example, FIG. 5 may describe the signaling in reference to an F1 interface between a CU 160 and a DU 165, FIG. 6 may describe the signaling in reference to an Xn interface between a first network entity 105 and a second network entity 105 and, FIG. 7 may describe the signaling in reference to an E1 interface between a CU-UP and a CU-CP.

FIG. 5 shows an example of a process flow 500 and a process flow 501 that supports techniques for notifying PDU set based quality of service reports in accordance with one or more aspects of the present disclosure. In some examples, the process flow 500 and the process flow 501 may implement or may be implemented by the wireless communications system 100, the network architecture 200, the wireless communications system 300, or any combination thereof. The process flow 500 and the process flow 501 may include a DU 505 and a CU 510 which may be examples of devices or services described elsewhere herein including with reference to FIGS. 1 through 3. Further, in some examples, the DU 505 and the CU 510 may be associated with a first network entity 105. In some other examples, the DU 505 may be referred to as a first RAN node and the CU 510 may be referred to as a second node. Moreover, in some cases, the DU 505 and the CU 510 may communicate via an interface between the DU 505 and the CU 510. In some examples, the interface may be an F1 interface that is for communications between components (e.g., a CU 160 and a DU 165) of a network entity 105.

In the following description of the process flow 500 and process flow 501, the operations may be performed by the DU 505 and the CU 510 in different orders or at different times. Some operations may also be left out of the process flow 500 and process flow 501, or other operations may be added. Although the process flow 500 and process flow 501 may be described as being performed by the DU 505 and the CU 510, some aspects of some operations may also be performed by other devices, services, or models described elsewhere herein including with reference to FIGS. 1 through 3.

In some examples, the process flow 500 may illustrate a UE 115 context setup procedure to establish the context of a UE 115. For example, the UE 115 context setup procedure may establish a signaling radio bearer (SRB), a DRB, a backhaul (BH) radio link control (RLC) channel, a Uu relay RLC channel, a PC5 relay RLC channel, a sidelink DRB configuration, or any combination thereof. At 515, the CU 510 may initiate the UE 115 context setup procedure by transmitting a UE context setup request message to the CU 510. Thus, at 520, if the DU 505 is successful in establishing the UE 115 context, the DU 505 may transmit a UE 115 context setup response message to the CU 510.

In some examples, the process flow 501 may illustrate a UE 115 context modification procedure to modify the UE 115 context that is established. For example, the modification procedure may include modifying and releasing radio resources and sidelink resources. Further, in some cases, the procedure may also be used to command the DU 505 to stop data transmissions for a UE 115 for mobility. At 525, to initiate the procedure, the CU 510 may transmit a UE 115 context modification request message to the DU 505. Based on receiving the request message, at 530, the DU 505 may perform the modifications and if successful, transmit a UE 115 context modification response message to the CU 510.

In some examples, in accordance with the techniques of the present disclosure, a first RAN node (e.g., the DU 505) may receive, from a second node (e.g., the CU 510) the first message, that configures the first RAN node to transmit a quality of service report for at least one data traffic flow that includes one or more PDU sets, via one or more first messages, on an interface between the first RAN node and the second node. Further, as the first RAN node may be the DU 505 and the second node may be the CU 510, the interface between the first RAN node and the second node may be an F1 interface. Moreover, in some examples, the F1 interface may be a wireless interface, a wired interface, or a combination thereof.

Further, in some examples, the DU 505 may receive the configuration from the CU 510 via the UE context setup request message received at 515, the UE context modification request message received at 525, or a combination thereof. In some cases, the configuration for the PDU set based quality of service notifications may be added at the quality of service flow level (e.g., the data traffic flow level) within one or more information elements. For example, the DU 505 may receive the configuration via a DRB to be setup list information element, a DRB to be modified list information element, or both. Moreover, the DU 505 may receive the configuration for PDU set based quality of service notifications from the CU 510 via such messages based on an inclusion of a PDU set notification control information element. Additionally, or alternatively, if the PDU set notification control information element is present, the DU 505 may determine that a PDU set based quality of service notification is requested. Otherwise, if the PDU set notification control information element is absent, DU 505 may determine that a PDU set based quality of service notification is not requested. Further, the PDU set notification control information element may indicate whether the PDU set based notification control for a respective DRB is active or inactive.

In another example, the first RAN node (e.g., the DU 505) may receive, from the second node (e.g., the CU 510), an indication of one or more additional quality of service parameters that are associated with PDU sets (e.g., alternative PDU set based quality of service parameters) via the one or more first messages on the interface between the first RAN node and the second node. For example, the second node (e.g., the CU 510) may configure the first RAN node (e.g., the DU 505) with an alternative PDU set based quality of service set list through one or more F1 messages. For example, the DU 505 may receive the alternative PDU set based quality of service set list via the UE context setup request message received at 515, the UE context modification request message received at 525, or a combination thereof.

Further, in the UE context setup request message and the UE context modification request message, the alternative PDU set based quality of service set list may be added to a PDU set based alternative quality of service profile list may be added to an information element that indicates GBR quality of service flow information. Moreover, the information element for the GBR quality of service flow information may indicate quality of service parameters for a GBR quality of service flow (e.g., data traffic flow) or GBR bearer for downlink and uplink. Further, the alternative PDU set quality of service parameters set list may be added to the information element to indicated alternative sets of PDU set based quality of service parameters for the quality of service flow. Additionally, or alternatively, the additional quality of service parameters may be included via a current quality of service parameters set index within a UE 115 contest setup response information element, or a UE 115 context modification response information element, associated with an alternative quality of service parameters set index information element, or via a notify information element associated with an alternative quality of service parameters set notify index information element.

Further, in accordance with the techniques of the present disclosure, the first RAN node (e.g., the DU 505) may transmit, to the second node (e.g., the CU 510), an indication of the capability of the first RAN node (e.g., a capability to support transmitting PDU set based quality of service notifications) via one or more second messages on the interface between the first RAN node and the second node. In some cases, the DU 505 may transmit the capability of the DU 505 to the CU 510 to indicate whether the DU 505 is capable of supporting PDU set based quality of service notifications when a UE 115 context is setup or modified. For example, the DU 505 may transmit the indication of the capability of the DU 505 to the CU 510 via the UE 115 context setup response message transmitted at 520, the UE 115 context modification response message transmitted at 530, or both. Moreover, within the F1 interface, the indication of the DU 505 being capable of supporting PDU set information marking (e.g., PDU set based quality of service notifications) may be added at the UE 115 level. Additionally, or alternatively, the DU 505 may add the indication of the capability of the DU 505 to the one or more messages via a PDU set based quality of service notification indicator. For example, the DU 505 may add the PDU set based quality of service notification indicator to the UE 115 context setup response message that is used to confirm the setup of a UE 115 context.

Further descriptions of the techniques of the present disclosure may be described elsewhere herein. For example, FIGS. 6 through 7 may describe the first RAN node receiving the first message from the second node configuring the first RAN node, the first RAN node receiving one or more additional quality of service parameters associated with PDU sets from the second node, the first RAN node transmitting an indication of the capability of the first RAN node to the second node, or any combination thereof, with respect to one or more other interfaces between the first RAN node and the second node. For example, FIG. 6 may describe the signaling in reference to an Xn interface between a first network entity 105 and a second network entity 105 and FIG. 7 may describe the signaling in reference to an E1 interface between a CU-UP and a CU-CP.

FIG. 6 shows an example of a process flow 600, a process flow 601, and a process flow 602 that supports techniques for notifying PDU set based quality of service reports in accordance with one or more aspects of the present disclosure. In some examples, the process flow 600, the process flow 601, and the process flow 602, may implement or may be implemented by the wireless communications system 100, the network architecture 200, the wireless communications system 300, or any combination thereof. the process flow 600, the process flow 601, and the process flow 602, may include an M-NG-RAN node 605 (e.g., a main or master node), an S-NG-RAN node 610 (e.g., a secondary node), a source RAN node 615, and a target RAN node 620 which may be examples of devices or services described elsewhere herein including with reference to FIGS. 1 through 3. Further, in some examples, the DU 505 and the CU 510 may be associated with a first network entity 105. In some other examples, the DU 505 may be referred to as a first RAN node and the CU 510 may be referred to as a second node. Moreover, in some cases, the DU 505 and the CU 510 may communicate via an interface between the DU 505 and the CU 510. In some examples, the interface may be an F1 interface that is for communications between components (e.g., a CU 160 and a DU 165) of a network entity 105.

In the following description of the process flow 600, the process flow 601, and the process flow 602, the operations may be performed by the M-NG-RAN node 605, the S-NG-RAN node 610, the source RAN node 615, the target RAN node 620 in different orders or at different times. Some operations may also be left out of the process flow 600, the process flow 601, and the process flow 602, or other operations may be added. Although the process flow 600, the process flow 601, and the process flow 602 may be described as being performed by the M-NG-RAN node 605, the S-NG-RAN node 610, the source RAN node 615, the target RAN node 620, some aspects of some operations may also be performed by other devices, services, or models described elsewhere herein including with reference to FIGS. 1 through 3.

In some examples, the process flow 600 may illustrate an addition preparation procedure to request that the S-NG-RAN node 610 allocate resources for dual connectivity operations for a UE 115. Moreover, possible parallel requests may be identified by a primary cell (PCell) identifier when the initiating NG-RAN node (e.g., the M-NG-RAN node 605) UE access point (AP) identifiers are the same. Thus, at 625, the M-NG-RAN node 605 may initiate the procedure by transmitting a S-Node addition request message to the S-NG-RAN node 610. In some examples, the M-NG-RAN node 605 may also start a timer after transmission of the S-Node addition request message. Further, at 630, the S-NG-RAN node 610 may transmit a S-Node addition request acknowledge message to the M-NG-RAN node 605 and the M-NG-RAN node 605 may subsequently stop the timer.

In some examples, the process flow 601 may illustrate a procedure that enables the M-NG-RAN node 605 to request the S-NG-RAN node 610 to modify the UE 115 context at the S-NG-RAN node 610, query a configuration (e.g., a secondary cell group (SCG) configuration) for supporting delta signaling (e.g., a signaling mechanism for efficient control information transmissions between a network entity 105 and a UE 115) in M-NG-RAN node 605 initiated S-NG-RAN node 610 change, to provide radio link failure (RLF) related information to the S-NG-RAN node 610, or any combination thereof. At 635, the M-NG-RAN node 605 may initiate the procedure by transmitting an S-Node modification request message to the S-NG-RAN node 610 and starting an associated timer. In response, at 640, the S-NG-RAN node 610 may transmit an S-Node modification request acknowledge message to the M-NG-RAN node 605 and the M-NG-RAN node 605 may stop the corresponding timer.

In another example, the process flow 602 may illustrate a Xn handover procedure for a UE 115 from being connected to the source RAN node 615 to the target RAN node 620. At 645, the source RAN node 615 may initiate the handover procedure by transmitting a handover request message to the target RAN node 620. In response, at 650, the target RAN node 620 may accept the handover request and transmit a handover request acknowledge message to the source RAN node 615. Based on receiving the handover request acknowledge message, the source RAN node 615 may then communicate with a UE 115 to enable the UE 115 to initiate the handover procedure from the source RAN node 615 to the target RAN node 620.

In some examples, in accordance with the techniques of the present disclosure, a first RAN node (e.g., the S-NG-RAN node 610 or the target RAN node 620) may receive, from a second node (e.g., the M-NG-RAN node 605 or the source RAN node 615) the first message, that configures the first RAN node to transmit a quality of service report for at least one data traffic flow that includes one or more PDU sets, via one or more first messages, on an interface between the first RAN node and the second node. Further, as the first RAN node may be the S-NG-RAN node 610 or the target RAN node 620 and the second node may be the M-NG-RAN node 605 or the source RAN node 615, the interface between the first RAN node and the second node may be an Xn interface. For example, the first RAN node may be a first network entity 105 and the second node may be a second network entity 105 and the interface between the first network entity 105 and the second network entity 105 may be an Xn interface. Moreover, in some examples, the Xn interface may be a wireless interface, a wired interface, or a combination thereof.

Further, in some examples, if a UE 115 is configured with dual connectivity, the S-NG-RAN node 610 may receive the configuration from the M-NG-RAN node 605 via the S-Node addition request message received at 625, the S-Node modification request message received at 635, or a combination thereof. In some other examples, the source RAN node 615 may configure the target RAN node 620 with the configuration to transmit PDU set based quality of service notifications through the Xn handover request message received at 645. In some cases, the S-NG-RAN node 610, the target RAN node 620, or both may receive the configuration based on a PDU set notification control information element being added to an information element used for indicating GBR quality of service flow information (e.g., GBR data traffic flow information). For example, the configuration may be added via a PDU session resources to be setup list information element of a handover request message where PDU session resources to be setup list information element includes a quality of service flow level quality of service parameters information element. Moreover, the quality of service flow level quality of service parameters information element may include an information element to indicate GBR quality of service flow information and such information element may include the PDU set notification control information element. Additionally, or alternatively, if the PDU set notification control information element is present, the S-NG-RAN node 610 or the target RAN node 620 may determine that a PDU set based quality of service notification is requested. Otherwise, if the PDU set notification control information element is absent, the S-NG-RAN node 610 or the target RAN node 620 may determine that a PDU set based quality of service notification is not requested.

In another example, the first RAN node (e.g., S-NG-RAN node 610, the target RAN node 620) may receive, from the second node (e.g., the M-NG-RAN node 605, the source RAN node 615), an indication of one or more additional quality of service parameters that are associated with PDU sets (e.g., alternative PDU set based quality of service parameters) via the one or more first messages on the interface between the first RAN node and the second node. For example, the second node may configure the first RAN node with an alternative PDU set based quality of service set list through one or more Xn messages. For example, the S-NG-RAN node 610 may receive the alternative PDU set based quality of service set list via the S-Node addition request message received at 625, the S-Node modification request message received at 635, or a combination thereof. Further, in such messages, a PDU set based alternative quality of service profile list may be added to an information element used for indicating GBR quality of service flow information (e.g., GBR data traffic flow information). Moreover, the information element for the GBR quality of service flow information may indicate quality of service parameters for a GBR quality of service flow. Further, the alternative PDU set quality of service parameters set list may be added to the information element to indicated alternative sets of PDU set based quality of service parameters for the quality of service flow.

Additionally, or alternatively, the additional quality of service parameters may be included via a current quality of service parameters set index within PDU session resources admitted list information elements, a PDU session resource setup response info—master node (MN) or secondary node (SN) terminated information element, a PDU session resource modification response info—MN or SN terminated information element, or any combination thereof within the alternative quality of service parameters set index information element. Further, the additional quality of service parameters may be included via a current quality of service parameters set index within an alternative quality of service parameters set notify index.

Further, in accordance with the techniques of the present disclosure, the first RAN node (e.g., the S-NG-RAN node 610 or the target RAN node 620) may transmit, to the second node (e.g., the M-NG-RAN node 605 or the source RAN node 615), an indication of the capability of the first RAN node (e.g., a capability to support transmitting PDU set based quality of service notifications) via one or more second messages on the interface between the first RAN node and the second node. In some cases, the S-NG-RAN node 610 may transmit the capability of the first RAN node to the M-NG-RAN node 605 to indicate whether the first RAN node is capable of supporting PDU set based quality of service notifications when a UE 115 is configured with dual connectivity. For example, the S-NG-RAN node 610 may may transmit the indication of the capability of the S-NG-RAN node 610 to the M-NG-RAN node 605 via the S-Node addition request acknowledge message transmitted at 630, the S-Node modification request acknowledge message transmitted at 640, or both. Further, the source RAN node 615 may indicate the support for the PDU set base quality of service notifications via a PDU session resources admitted to be added item information element within the S-Node addition request acknowledge message and via a PDU session resources admitted to be added list information element and a PDU session resources admitted to be modified list information element, both within the S-Node modification acknowledge message. Moreover, the S-NG-RAN node 610 may add the indication of the capability of the S-NG-RAN node 610 to the one or more messages via a PDU set based quality of service notification indicator as described elsewhere herein.

Further descriptions of the techniques of the present disclosure may be described elsewhere herein. For example, FIG. 7 may describe the first RAN node receiving one or more additional quality of service parameters associated with PDU sets from the second node with respect to an E1 interface between a CU-UP and a CU-CP.

FIG. 7 shows an example of a process flow 700 and a process flow 701 that supports techniques for notifying PDU set based quality of service reports in accordance with one or more aspects of the present disclosure. In some examples, the process flow 700 and the process flow 701, may implement or may be implemented by the wireless communications system 100, the network architecture 200, the wireless communications system 300, or any combination thereof. The process flow 700 and the process flow 701, may include a CU-CP 705 and a CU-UP 710 which may be examples of devices or services described elsewhere herein including with reference to FIGS. 1 through 3. Further, in some examples, the CU-CP 705 and the CU-UP 710 may be associated with a first network entity 105. In some other examples, the CU-UP 710 may be referred to as a first RAN node and the CU-CP 705 may be referred to as a second node. Moreover, in some cases, the CU-CP 705 and the CU-UP 710 may communicate via an interface between the CU-CP 705 and the CU-UP 710. In some examples, the interface may be an E1 interface that is for communications between components of a network entity 105, such as a CU 160 associated with the control plane of the network entity 105 and a CU 160 associated with the user plane of the network entity 105.

In the following description of the process flow 700 and the process flow 701, the operations may be performed by the CU-CP 705 and the CU-UP 710 in different orders or at different times. Some operations may also be left out of the process flow 700 and the process flow 701, or other operations may be added. Although the process flow 700 and the process flow 701 may be described as being performed by the CU-CP 705 and the CU-UP 710, some aspects of some operations may also be performed by other devices, services, or models described elsewhere herein including with reference to FIGS. 1 through 3.

In some examples, the process flow 700 may illustrate a network entity 105 establishing bearer context between CP and UP of a respective CU 160. For example, at 715, the CU-CP 705 may transmit a bearer context setup request message to the CU-UP 710 to establish the bearer context in the CU-UP 710. In response, at 720, the CU-UP 710 may transmit a bearer context setup response message to the CU-CP 705 that includes an F1-U uplink tunnel endpoint identifier (TEID) and transport layer address allocated by the CU-UP 710.

In some other examples, the process flow 701 may illustrate the CP and UP modifying the bearer context. For example, at 725, the CU-CP 705 may transmit a bearer context modification request message to the CU-UP 710 that includes an F1-U downlink TEID and a transport layer address allocated by the DU 165 of the associated network entity 105. In response, at 730, the CU-UP 710 may then transmit a bearer context modification response message to the CU-CP 705.

In some examples, in accordance with the techniques of the present disclosure, the first RAN node (e.g., the CU-UP 710) may receive, from the second node (e.g., the CU-CP 705), an indication of one or more additional quality of service parameters that are associated with PDU sets (e.g., alternative PDU set based quality of service parameters) via one or more first messages on an interface between the first RAN node and the second node (e.g., the E1 interface between the CU-CP 705 and the CU-UP 710). Further, as the first RAN node may be the CU-UP 710 and the second node may be the CU-CP 705, the interface between the first RAN node and the second node may be an E1 interface that is between the CP and UP of a CU 160 of a network entity 105. Moreover, in some examples, the E1 interface may be a wireless interface, a wired interface, or a combination thereof.

In some cases, the second node (e.g., the CU-CP 705) may configure the first RAN node (e.g., the CU-UP 710) with an alternative PDU set based quality of service set list through one or more E1 messages. For example, the CU-UP 710 may receive the alternative PDU set based quality of service set list via the bearer context setup request message received at 715, the bearer context modification request message received at 725, or a combination thereof. Further, in such messages, a PDU set based alternative quality of service profile list may be added to an E1 information element used for indicating GBR quality of service flow information (e.g., GBR data traffic flow information). Moreover, the information element for the GBR quality of service flow information may indicate quality of service parameters for a GBR quality of service flow for downlink and uplink communications. Thus, the alternative PDU set quality of service parameters set list may be added to the information element to indicate alternative sets of PDU set based quality of service parameters for the quality of service flow.

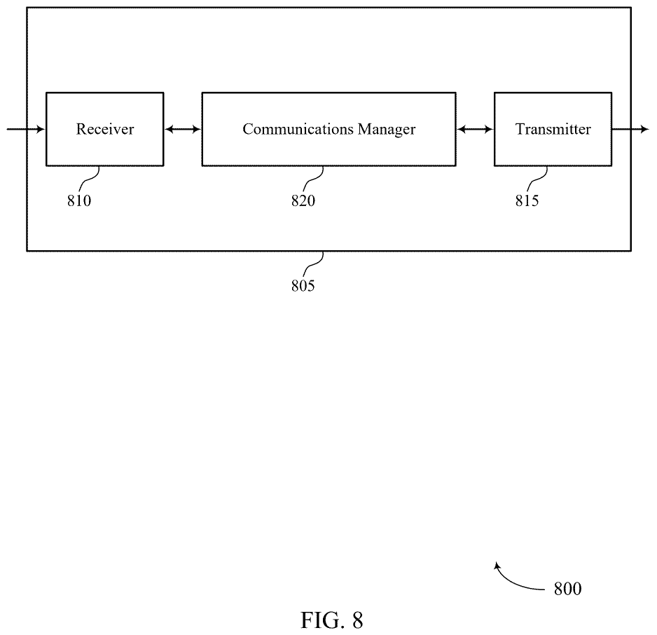

Therefore, the CU-UP 710 may receive the configuration of the additional one or more quality of service parameters via the E1 interface. In some examples, in accordance with the techniques of the present disclosure, the configuration for the first RAN node to transmit PDU set based quality of service notifications may be received via a message on one or more other interfaces (e.g., the NG interface, the F1 interface, the XN interface, or any combination thereof). Further, the first RAN node (e.g., the CU-UP 710) may transmit an indication of the capability of the first RAN node to transmit the PDU set based quality of service notifications via a message on the one or more other interfaces in accordance with the techniques of the present disclosure. Thus, the techniques of the present disclosure may enable the use of PDU set based quality of service notifications which may result in more efficient and reliable communications within a wireless communication system (e.g., the wireless communications system 100, the network architecture 200, the wireless communications system 300, or any combination thereof). Further description of the techniques of the present disclosure may be described elsewhere herein, such as with reference to FIGS. 8 through 17.

FIG. 8 shows a block diagram 800 of a device 805 that supports techniques for notifying PDU set based quality of service reports in accordance with one or more aspects of the present disclosure. The device 805 may be an example of aspects of a network entity 105 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to, individually or collectively, support or enable the described techniques. Each of these components may be in communication with one another (e.g., via one or more buses).

The receiver 810 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 805. In some examples, the receiver 810 may support obtaining information by receiving signals via one or more antennas. Additionally, or alternatively, the receiver 810 may support obtaining information by receiving signals via one or more wired (e.g., electrical, fiber optic) interfaces, wireless interfaces, or any combination thereof.

The transmitter 815 may provide a means for outputting (e.g., transmitting, providing, conveying, sending) information generated by other components of the device 805. For example, the transmitter 815 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 815 may support outputting information by transmitting signals via one or more antennas. Additionally, or alternatively, the transmitter 815 may support outputting information by transmitting signals via one or more wired (e.g., electrical, fiber optic) interfaces, wireless interfaces, or any combination thereof. In some examples, the transmitter 815 and the receiver 810 may be co-located in a transceiver, which may include or be coupled with a modem.

The communications manager 820, the receiver 810, the transmitter 815, or various combinations or components thereof may be examples of means for performing various aspects of techniques for notifying PDU set based quality of service reports as described herein. For example, the communications manager 820, the receiver 810, the transmitter 815, or various combinations or components thereof may be capable of performing one or more of the functions described herein.

In some examples, the communications manager 820, the receiver 810, the transmitter 815, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 820, the receiver 810, the transmitter 815, or various combinations or components thereof may be implemented in code (e.g., as communications management software or firmware) executed by at least one processor (e.g., referred to as a processor-executable code). If implemented in code executed by at least one processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. For example, the communications manager 820 is capable of, configured to, or operable to support a means for receiving, from a second node, a first message that configures the first RAN node to transmit a quality of service report for at least one data traffic flow that includes one or more PDU sets, where the quality of service report includes quality of service information on a per PDU set basis. The communications manager 820 is capable of, configured to, or operable to support a means for transmitting a quality of service notification for the at least one data traffic flow to the second node, where the quality of service notification is based on a capability of the first RAN node to report quality of service on a per PDU set basis in accordance with the first message.

By including or configuring the communications manager 820 in accordance with examples as described herein, the device 805 (e.g., at least one processor controlling or otherwise coupled with the receiver 810, the transmitter 815, the communications manager 820, or a combination thereof) may support techniques for a RAN node to transmit a quality of service notification on a per PDU set basis to support reduced processing, reduced power consumption, and more efficient utilization of communication resources.

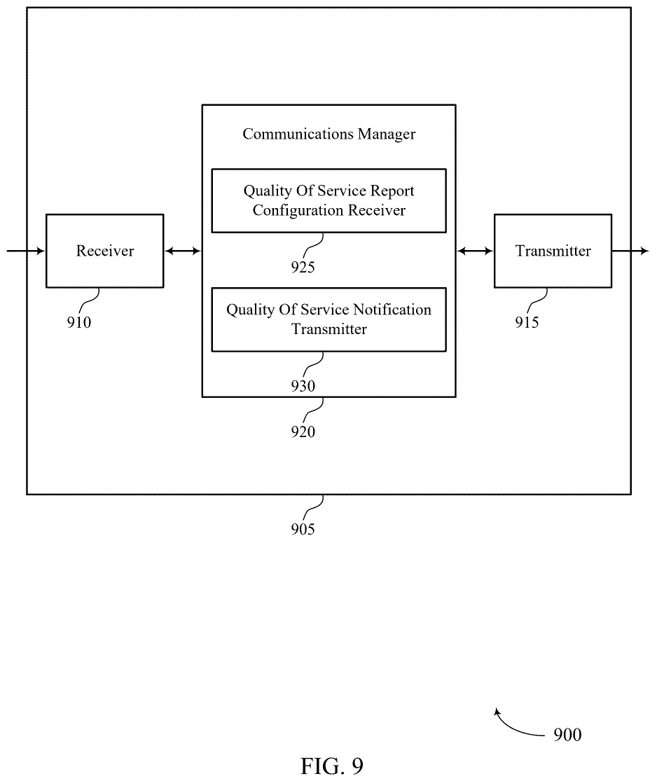

FIG. 9 shows a block diagram 900 of a device 905 that supports techniques for notifying PDU set based quality of service reports in accordance with one or more aspects of the present disclosure. The device 905 may be an example of aspects of a device 805 or a network entity 105 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to support the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The device 905, or various components thereof, may be an example of means for performing various aspects of techniques for notifying PDU set based quality of service reports as described herein. For example, the communications manager 920 may include a quality of service report configuration receiver 925 a quality of service notification transmitter 930, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. The quality of service report configuration receiver 925 is capable of, configured to, or operable to support a means for receiving, from a second node, a first message that configures the first RAN node to transmit a quality of service report for at least one data traffic flow that includes one or more PDU sets, where the quality of service report includes quality of service information on a per PDU set basis. The quality of service notification transmitter 930 is capable of, configured to, or operable to support a means for transmitting a quality of service notification for the at least one data traffic flow to the second node, where the quality of service notification is based on a capability of the first RAN node to report quality of service on a per PDU set basis in accordance with the first message.

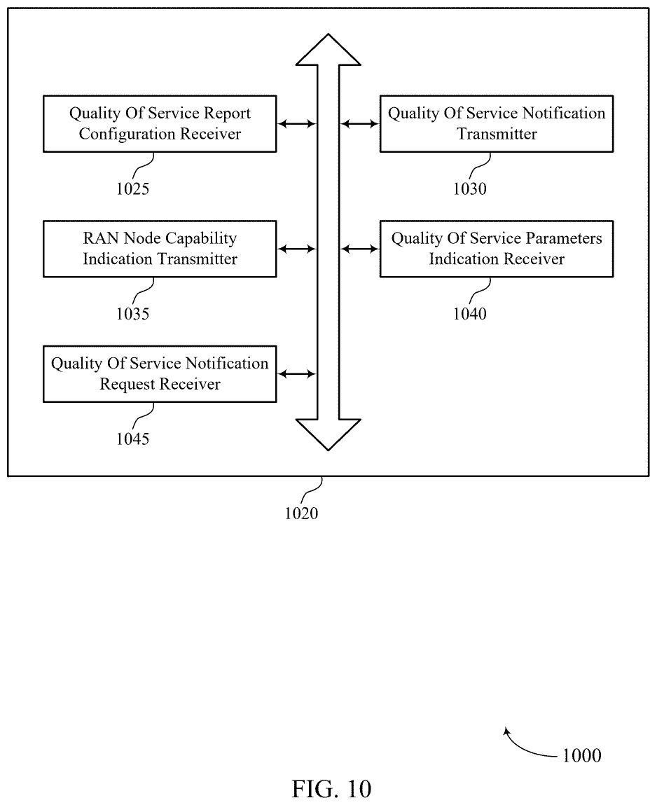

FIG. 10 shows a block diagram 1000 of a communications manager 1020 that supports techniques for notifying PDU set based quality of service reports in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of techniques for notifying PDU set based quality of service reports as described herein. For example, the communications manager 1020 may include a quality of service report configuration receiver 1025, a quality of service notification transmitter 1030, a RAN node capability indication transmitter 1035, a quality of service parameters indication receiver 1040, a quality of service notification request receiver 1045, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1020 may support wireless communications in accordance with examples as disclosed herein. The quality of service report configuration receiver 1025 is capable of, configured to, or operable to support a means for receiving, from a second node, a first message that configures the first RAN node to transmit a quality of service report for at least one data traffic flow that includes one or more PDU sets, where the quality of service report includes quality of service information on a per PDU set basis. The quality of service notification transmitter 1030 is capable of, configured to, or operable to support a means for transmitting a quality of service notification for the at least one data traffic flow to the second node, where the quality of service notification is based on a capability of the first RAN node to report quality of service on a per PDU set basis in accordance with the first message.

In some examples, the RAN node capability indication transmitter 1035 is capable of, configured to, or operable to support a means for transmitting, to the second node, an indication of the capability of the first RAN node to report the quality of service on a per PDU set basis, the indication of the capability being transmitted in response to reception of the first message.

In some examples, the quality of service notification request receiver 1045 is capable of, configured to, or operable to support a means for receiving, from the second node and in response to transmission of the indication of the capability of the first RAN node, a request to transmit the quality of service notification for the at least one data traffic flow on a per PDU set basis in accordance with the capability of the first RAN node, where transmission of the quality of service notification is based on reception of the request.

In some examples, the indication of the capability of the first RAN node to report the quality of service on a per PDU set basis is transmitted via an information element on an interface between the first RAN node and the second node.

In some examples, to support transmitting the quality of service notification, the quality of service notification transmitter 1030 is capable of, configured to, or operable to support a means for transmitting the quality of service notification to the second node in response to reception of the first message, where transmission of the quality of service notification is based on the capability of the first RAN node.

In some examples, the second node is an access and mobility function, and the quality of service report configuration receiver 1025 is capable of, configured to, or operable to support a means for receiving, from the second node, the first message via one or more first messages on an interface between the first RAN node and the second node. In some examples, the second node is an access and mobility function, and the RAN node capability indication transmitter 1035 is capable of, configured to, or operable to support a means for transmitting, to the second node, an indication of the capability of the first RAN node via one or more second messages on the interface between the first RAN node and the second node.

In some examples, the quality of service parameters indication receiver 1040 is capable of, configured to, or operable to support a means for receiving, from the second node, an indication of one or more additional quality of service parameters that are associated with PDU sets via the one or more first messages on the interface between the first RAN node and the second node.

In some examples, the one or more first messages include a PDU session resource setup request message, a PDU session modification request message, a path switch request acknowledgment message, or any combination thereof. In some examples, the one or more second messages include a PDU session resource setup response message, a PDU session modification response message, a path switch request message, or any combination thereof.

In some examples, the first message is associated with the at least one data traffic flow and the indication of the capability of the first RAN node is associated with a quality of service flow associated with the at least one data traffic flow, a PDU session, or both.

In some examples, the first RAN node is a distributed unit of a first network entity and the second node is a centralized unit of the first network entity, and the quality of service report configuration receiver 1025 is capable of, configured to, or operable to support a means for receiving, from the second node, the first message via one or more first messages on an interface between the first RAN node and the second node. In some examples, the first RAN node is a distributed unit of a first network entity and the second node is a centralized unit of the first network entity, and the RAN node capability indication transmitter 1035 is capable of, configured to, or operable to support a means for transmitting, to the second node, an indication of the capability of the first RAN node via one or more second messages on the interface between the first RAN node and the second node.

In some examples, the quality of service parameters indication receiver 1040 is capable of, configured to, or operable to support a means for receiving, from the second node, an indication of one or more additional quality of service parameters that are associated with PDU sets via the one or more first messages on the interface between the first RAN node and the second node.

In some examples, the one or more first messages include a context setup request message, a context modification request message, or a combination thereof. In some examples, the one or more second messages include a context setup response message, a context modification response message, or a combination thereof.

In some examples, the first message is associated with a quality of service flow associated with the at least one data traffic flow and the indication of the capability of the first RAN node is associated with a UE context.

In some examples, the first RAN node is a first network entity and the second node is a second network entity, and the quality of service report configuration receiver 1025 is capable of, configured to, or operable to support a means for receiving, from the second node, the first message via one or more first messages on an interface between the first RAN node and the second node. In some examples, the first RAN node is a first network entity and the second node is a second network entity, and the RAN node capability indication transmitter 1035 is capable of, configured to, or operable to support a means for transmitting, to the second node, an indication of the capability of the first RAN node via one or more second messages on the interface between the first RAN node and the second node.

In some examples, the quality of service parameters indication receiver 1040 is capable of, configured to, or operable to support a means for receiving, from the second node, an indication of one or more additional quality of service parameters that are associated with PDU sets via the one or more first messages on the interface between the first RAN node and the second node.

In some examples, the one or more first messages include a handover request message, an addition request message, a modification request message, or a combination thereof. In some examples, the one or more second messages include an addition request acknowledge message, a modification request acknowledge message, or a combination thereof.

In some examples, the first RAN node is a centralized unit of a first network entity that is associated with a user plane and the second node is the centralized unit of the first network entity that is associated with a control plane, and the quality of service parameters indication receiver 1040 is capable of, configured to, or operable to support a means for receiving, from the second node, an indication of one or more additional quality of service parameters that are associated with PDU sets via one or more first messages on an interface between the first RAN node and the second node.

In some examples, the one or more first messages include a bearer context setup request message, a bearer context modification request message, or a combination thereof.

In some examples, the first message is transmitted via an information element on an interface between the first RAN node and the second node and a presence of the information element indicates a request for the quality of service notification that is on a PDU set basis.

In some examples, the quality of service parameters indication receiver 1040 is capable of, configured to, or operable to support a means for receiving, from the second node, an indication of one or more additional quality of service parameters that are associated with PDU sets via an information element on an interface between the first RAN node and the second node.

In some examples, the one or more additional quality of service parameters includes a PDU set packet delay budget parameter, a PDU set error rate, or both.

In some examples, the indication of the one or more additional quality of service parameters associated with PDU sets are indicated via a set of indexes associated with one or more quality of service parameters that are associated with PDUs of PDU sets.

In some examples, an indication of one or more quality of service parameters associated with PDUs of PDU sets are indicated via a first subset of indexes of a set of indexes and the indication of the one or more additional quality of service parameters associated with PDU sets are indicated via a second subset of indexes of the set of indexes that is subsequent to the first subset of indexes.

In some examples, an indication of one or more quality of service parameters associated with PDUs of PDU sets are indicated via a first set of indexes and the indication of the one or more additional quality of service parameters associated with PDU sets are indicated via a second set of indexes that is different from the first set of indexes.

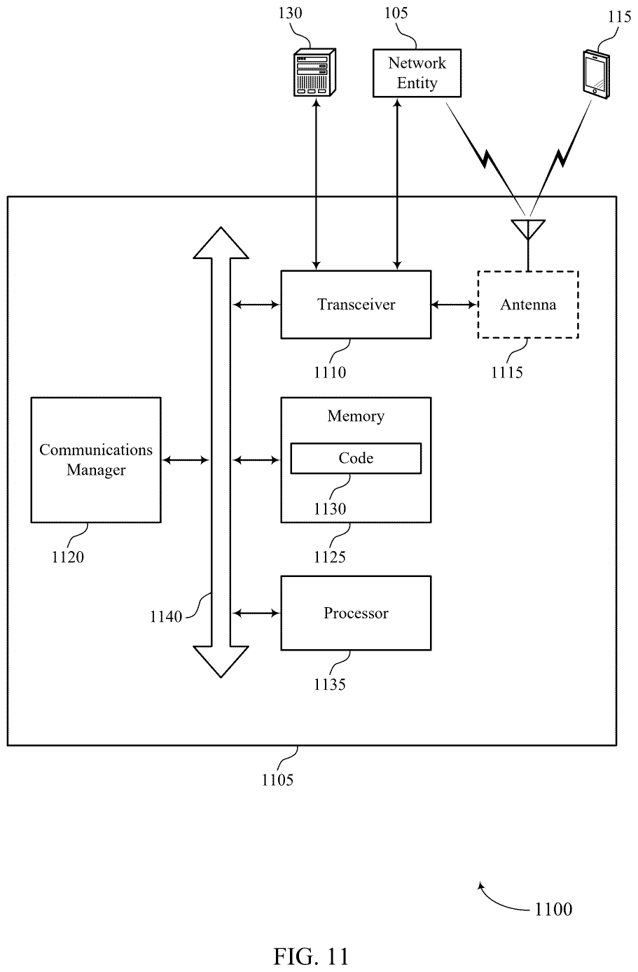

FIG. 11 shows a diagram of a system 1100 including a device 1105 that supports techniques for notifying PDU set based quality of service reports in accordance with one or more aspects of the present disclosure. The device 1105 may be an example of or include components of a device 805, a device 905, or a network entity 105 as described herein. The device 1105 may communicate with other network devices or network equipment such as one or more of the network entities 105, UEs 115, or any combination thereof. The communications may include communications over one or more wired interfaces, over one or more wireless interfaces, or any combination thereof. The device 1105 may include components that support outputting and obtaining communications, such as a communications manager 1120, a transceiver 1110, one or more antennas 1115, at least one memory 1125, code 1130, and at least one processor 1135. These components may be in electronic communication or otherwise coupled (e.g., operatively, communicatively, functionally, electronically, electrically) via one or more buses (e.g., a bus 1140).

The transceiver 1110 may support bi-directional communications via wired links, wireless links, or both as described herein. In some examples, the transceiver 1110 may include a wired transceiver and may communicate bi-directionally with another wired transceiver. Additionally, or alternatively, in some examples, the transceiver 1110 may include a wireless transceiver and may communicate bi-directionally with another wireless transceiver. In some examples, the device 1105 may include one or more antennas 1115, which may be capable of transmitting or receiving wireless transmissions (e.g., concurrently). The transceiver 1110 may also include a modem to modulate signals, to provide the modulated signals for transmission (e.g., by one or more antennas 1115, by a wired transmitter), to receive modulated signals (e.g., from one or more antennas 1115, from a wired receiver), and to demodulate signals. In some implementations, the transceiver 1110 may include one or more interfaces, such as one or more interfaces coupled with the one or more antennas 1115 that are configured to support various receiving or obtaining operations, or one or more interfaces coupled with the one or more antennas 1115 that are configured to support various transmitting or outputting operations, or a combination thereof. In some implementations, the transceiver 1110 may include or be configured for coupling with one or more processors or one or more memory components that are operable to perform or support operations based on received or obtained information or signals, or to generate information or other signals for transmission or other outputting, or any combination thereof. In some implementations, the transceiver 1110, or the transceiver 1110 and the one or more antennas 1115, or the transceiver 1110 and the one or more antennas 1115 and one or more processors or one or more memory components (e.g., the at least one processor 1135, the at least one memory 1125, or both), may be included in a chip or chip assembly that is installed in the device 1105. In some examples, the transceiver 1110 may be operable to support communications via one or more communications links (e.g., communication link(s) 125, backhaul communication link(s) 120, a midhaul communication link 162, a fronthaul communication link 168).

The at least one memory 1125 may include RAM, ROM, or any combination thereof. The at least one memory 1125 may store computer-readable, computer-executable, or processor-executable code, such as the code 1130. The code 1130 may include instructions that, when executed by one or more of the at least one processor 1135, cause the device 1105 to perform various functions described herein. The code 1130 may be stored in a non-transitory computer-readable medium such as system memory or another type of memory. In some cases, the code 1130 may not be directly executable by a processor of the at least one processor 1135 but may cause a computer (e.g., when compiled and executed) to perform functions described herein. In some cases, the at least one memory 1125 may include, among other things, a BIOS which may control basic hardware or software operation such as the interaction with peripheral components or devices. In some examples, the at least one processor 1135 may include multiple processors and the at least one memory 1125 may include multiple memories. One or more of the multiple processors may be coupled with one or more of the multiple memories which may, individually or collectively, be configured to perform various functions herein (for example, as part of a processing system).

The at least one processor 1135 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1135 may be configured to operate a memory array using a memory controller. In some other cases, a memory controller may be integrated into one or more of the at least one processor 1135. The at least one processor 1135 may be configured to execute computer-readable instructions stored in a memory (e.g., one or more of the at least one memory 1125) to cause the device 1105 to perform various functions (e.g., functions or tasks supporting techniques for notifying PDU set based quality of service reports). For example, the device 1105 or a component of the device 1105 may include at least one processor 1135 and at least one memory 1125 coupled with one or more of the at least one processor 1135, the at least one processor 1135 and the at least one memory 1125 configured to perform various functions described herein. The at least one processor 1135 may be an example of a cloud-computing platform (e.g., one or more physical nodes and supporting software such as operating systems, virtual machines, or container instances) that may host the functions (e.g., by executing code 1130) to perform the functions of the device 1105. The at least one processor 1135 may be any one or more suitable processors capable of executing scripts or instructions of one or more software programs stored in the device 1105 (such as within one or more of the at least one memory 1125).

In some examples, the at least one processor 1135 may include multiple processors and the at least one memory 1125 may include multiple memories. One or more of the multiple processors may be coupled with one or more of the multiple memories, which may, individually or collectively, be configured to perform various functions herein. In some examples, the at least one processor 1135 may be a component of a processing system, which may refer to a system (such as a series) of machines, circuitry (including, for example, one or both of processor circuitry (which may include the at least one processor 1135) and memory circuitry (which may include the at least one memory 1125)), or components, that receives or obtains inputs and processes the inputs to produce, generate, or obtain a set of outputs. The processing system may be configured to perform one or more of the functions described herein. For example, the at least one processor 1135 or a processing system including the at least one processor 1135 may be configured to, configurable to, or operable to cause the device 1105 to perform one or more of the functions described herein. Further, as described herein, being “configured to,” being “configurable to,” and being “operable to” may be used interchangeably and may be associated with a capability, when executing code stored in the at least one memory 1125 or otherwise, to perform one or more of the functions described herein.

In some examples, a bus 1140 may support communications of (e.g., within) a protocol layer of a protocol stack. In some examples, a bus 1140 may support communications associated with a logical channel of a protocol stack (e.g., between protocol layers of a protocol stack), which may include communications performed within a component of the device 1105, or between different components of the device 1105 that may be co-located or located in different locations (e.g., where the device 1105 may refer to a system in which one or more of the communications manager 1120, the transceiver 1110, the at least one memory 1125, the code 1130, and the at least one processor 1135 may be located in one of the different components or divided between different components).

In some examples, the communications manager 1120 may manage aspects of communications with a core network 130 (e.g., via one or more wired or wireless backhaul links). For example, the communications manager 1120 may manage the transfer of data communications for client devices, such as one or more UEs 115. In some examples, the communications manager 1120 may manage communications with one or more other network entities 105, and may include a controller or scheduler for controlling communications with UEs 115 (e.g., in cooperation with the one or more other network devices). In some examples, the communications manager 1120 may support an X2 interface within an LTE/LTE-A wireless communications network technology to provide communication between network entities 105.

The communications manager 1120 may support wireless communications in accordance with examples as disclosed herein. For example, the communications manager 1120 is capable of, configured to, or operable to support a means for receiving, from a second node, a first message that configures the first RAN node to transmit a quality of service report for at least one data traffic flow that includes one or more PDU sets, where the quality of service report includes quality of service information on a per PDU set basis. The communications manager 1120 is capable of, configured to, or operable to support a means for transmitting a quality of service notification for the at least one data traffic flow to the second node, where the quality of service notification is based on a capability of the first RAN node to report quality of service on a per PDU set basis in accordance with the first message.

By including or configuring the communications manager 1120 in accordance with examples as described herein, the device 1105 may support techniques for a RAN node to transmit a quality of service notification on a per PDU set basis to support improved communication reliability, reduced latency, improved user experience related to reduced processing, reduced power consumption, more efficient utilization of communication resources, improved coordination between devices, longer battery life, and improved utilization of processing capability.

In some examples, the communications manager 1120 may be configured to perform various operations (e.g., receiving, obtaining, monitoring, outputting, transmitting) using or otherwise in cooperation with the transceiver 1110, the one or more antennas 1115 (e.g., where applicable), or any combination thereof. Although the communications manager 1120 is illustrated as a separate component, in some examples, one or more functions described with reference to the communications manager 1120 may be supported by or performed by the transceiver 1110, one or more of the at least one processor 1135, one or more of the at least one memory 1125, the code 1130, or any combination thereof (for example, by a processing system including at least a portion of the at least one processor 1135, the at least one memory 1125, the code 1130, or any combination thereof). For example, the code 1130 may include instructions executable by one or more of the at least one processor 1135 to cause the device 1105 to perform various aspects of techniques for notifying PDU set based quality of service reports as described herein, or the at least one processor 1135 and the at least one memory 1125 may be otherwise configured to, individually or collectively, perform or support such operations.

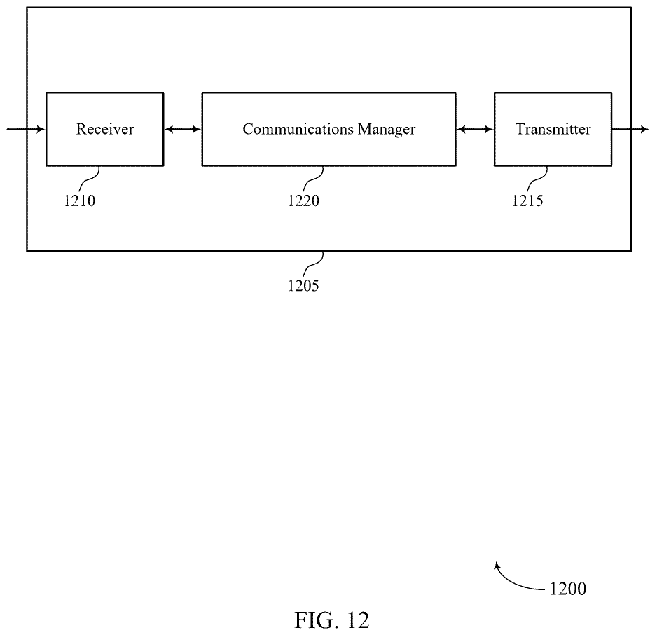

FIG. 12 shows a block diagram 1200 of a device 1205 that supports techniques for notifying PDU set based quality of service reports in accordance with one or more aspects of the present disclosure. The device 1205 may be an example of aspects of a UE 115 as described herein. The device 1205 may include a receiver 1210, a transmitter 1215, and a communications manager 1220. The device 1205, or one or more components of the device 1205 (e.g., the receiver 1210, the transmitter 1215, the communications manager 1220), may include at least one processor, which may be coupled with at least one memory, to, individually or collectively, support or enable the described techniques. Each of these components may be in communication with one another (e.g., via one or more buses).

The receiver 1210 may provide a means for receiving information such as packets, user data, control information, or any combination thereof associated with various information channels (e.g., control channels, data channels, information channels related to techniques for notifying PDU set based quality of service reports). Information may be passed on to other components of the device 1205. The receiver 1210 may utilize a single antenna or a set of multiple antennas.

The transmitter 1215 may provide a means for transmitting signals generated by other components of the device 1205. For example, the transmitter 1215 may transmit information such as packets, user data, control information, or any combination thereof associated with various information channels (e.g., control channels, data channels, information channels related to techniques for notifying PDU set based quality of service reports). In some examples, the transmitter 1215 may be co-located with a receiver 1210 in a transceiver component. The transmitter 1215 may utilize a single antenna or a set of multiple antennas.

The communications manager 1220, the receiver 1210, the transmitter 1215, or various combinations or components thereof may be examples of means for performing various aspects of techniques for notifying PDU set based quality of service reports as described herein. For example, the communications manager 1220, the receiver 1210, the transmitter 1215, or various combinations or components thereof may be capable of performing one or more of the functions described herein.

In some examples, the communications manager 1220, the receiver 1210, the transmitter 1215, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1220, the receiver 1210, the transmitter 1215, or various combinations or components thereof may be implemented in code (e.g., as communications management software or firmware) executed by at least one processor (e.g., referred to as a processor-executable code). If implemented in code executed by at least one processor, the functions of the communications manager 1220, the receiver 1210, the transmitter 1215, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1220 may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communications in accordance with examples as disclosed herein. For example, the communications manager 1220 is capable of, configured to, or operable to support a means for transmitting a request to receive a data traffic flow, where the data traffic flow includes one or more PDU sets and is associated with a quality of service. The communications manager 1220 is capable of, configured to, or operable to support a means for receiving the one or more PDU sets based on the quality of service being satisfied, where satisfaction of the quality of service is determined on a per PDU set basis.

By including or configuring the communications manager 1220 in accordance with examples as described herein, the device 1205 (e.g., at least one processor controlling or otherwise coupled with the receiver 1210, the transmitter 1215, the communications manager 1220, or a combination thereof) may support techniques for a UE to request for a data traffic flow and receive PDU sets of the data traffic flow based on a quality of service being satisfied on a per PDU set basis to support reduced processing, reduced power consumption, more efficient utilization of communication resources.

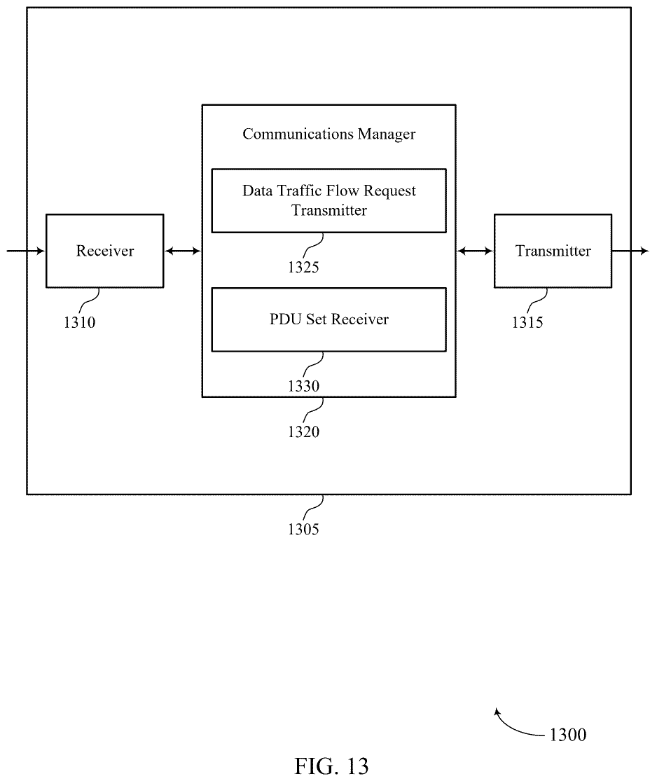

FIG. 13 shows a block diagram 1300 of a device 1305 that supports techniques for notifying PDU set based quality of service reports in accordance with one or more aspects of the present disclosure. The device 1305 may be an example of aspects of a device 1205 or a UE 115 as described herein. The device 1305 may include a receiver 1310, a transmitter 1315, and a communications manager 1320. The device 1305, or one or more components of the device 1305 (e.g., the receiver 1310, the transmitter 1315, the communications manager 1320), may include at least one processor, which may be coupled with at least one memory, to support the described techniques. Each of these components may be in communication with one another (e.g., via one or more buses).

The receiver 1310 may provide a means for receiving information such as packets, user data, control information, or any combination thereof associated with various information channels (e.g., control channels, data channels, information channels related to techniques for notifying PDU set based quality of service reports). Information may be passed on to other components of the device 1305. The receiver 1310 may utilize a single antenna or a set of multiple antennas.

The transmitter 1315 may provide a means for transmitting signals generated by other components of the device 1305. For example, the transmitter 1315 may transmit information such as packets, user data, control information, or any combination thereof associated with various information channels (e.g., control channels, data channels, information channels related to techniques for notifying PDU set based quality of service reports). In some examples, the transmitter 1315 may be co-located with a receiver 1310 in a transceiver component. The transmitter 1315 may utilize a single antenna or a set of multiple antennas.

The device 1305, or various components thereof, may be an example of means for performing various aspects of techniques for notifying PDU set based quality of service reports as described herein. For example, the communications manager 1320 may include a data traffic flow request transmitter 1325 a PDU set receiver 1330, or any combination thereof. The communications manager 1320 may be an example of aspects of a communications manager 1220 as described herein. In some examples, the communications manager 1320, or various components thereof, may be configured to perform various operations (e.g., receiving, obtaining, monitoring, outputting, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to obtain information, output information, or perform various other operations as described herein.

The communications manager 1320 may support wireless communications in accordance with examples as disclosed herein. The data traffic flow request transmitter 1325 is capable of, configured to, or operable to support a means for transmitting a request to receive a data traffic flow, where the data traffic flow includes one or more PDU sets and is associated with a quality of service. The PDU set receiver 1330 is capable of, configured to, or operable to support a means for receiving the one or more PDU sets based on the quality of service being satisfied, where satisfaction of the quality of service is determined on a per PDU set basis.

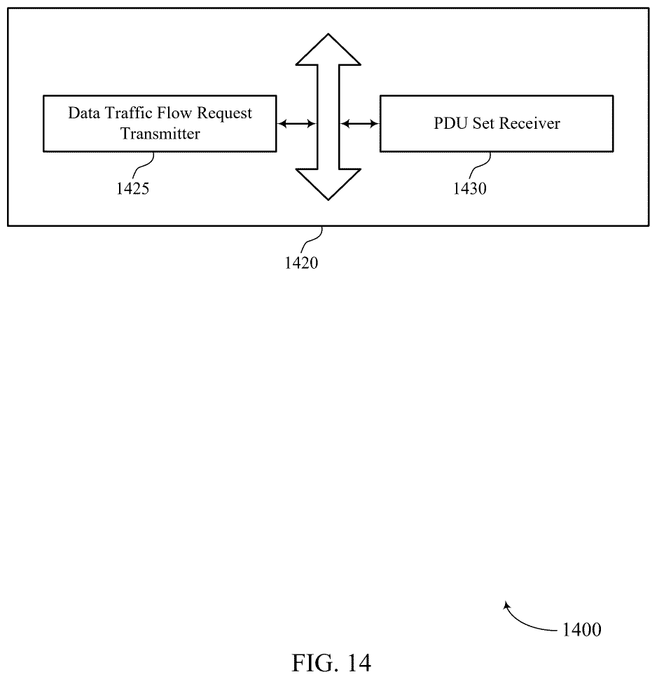

FIG. 14 shows a block diagram 1400 of a communications manager 1420 that supports techniques for notifying PDU set based quality of service reports in accordance with one or more aspects of the present disclosure. The communications manager 1420 may be an example of aspects of a communications manager 1220, a communications manager 1320, or both, as described herein. The communications manager 1420, or various components thereof, may be an example of means for performing various aspects of techniques for notifying PDU set based quality of service reports as described herein. For example, the communications manager 1420 may include a data traffic flow request transmitter 1425 a PDU set receiver 1430, or any combination thereof. Each of these components, or components or subcomponents thereof (e.g., one or more processors, one or more memories), may communicate, directly or indirectly, with one another (e.g., via one or more buses).

The communications manager 1420 may support wireless communications in accordance with examples as disclosed herein. The data traffic flow request transmitter 1425 is capable of, configured to, or operable to support a means for transmitting a request to receive a data traffic flow, where the data traffic flow includes one or more PDU sets and is associated with a quality of service. The PDU set receiver 1430 is capable of, configured to, or operable to support a means for receiving the one or more PDU sets based on the quality of service being satisfied, where satisfaction of the quality of service is determined on a per PDU set basis.

In some examples, satisfaction of the quality of service is based on satisfaction of one or more PDU set quality of service parameters.

In some examples, the one or more PDU set quality of service parameters include a PDU set delay budget parameter, a PDU set error rate parameter, a PDU set integrated handling information indicator, or any combination thereof.

In some examples, satisfaction of the quality of service is based on one or more thresholds being satisfied based on the one or more PDU set quality of service parameters.

In some examples, the one or more thresholds include a guaranteed bit rate threshold, a guaranteed flow bit rate threshold, a PDU set delay budget threshold, a PDU set error rate threshold, or any combination thereof.

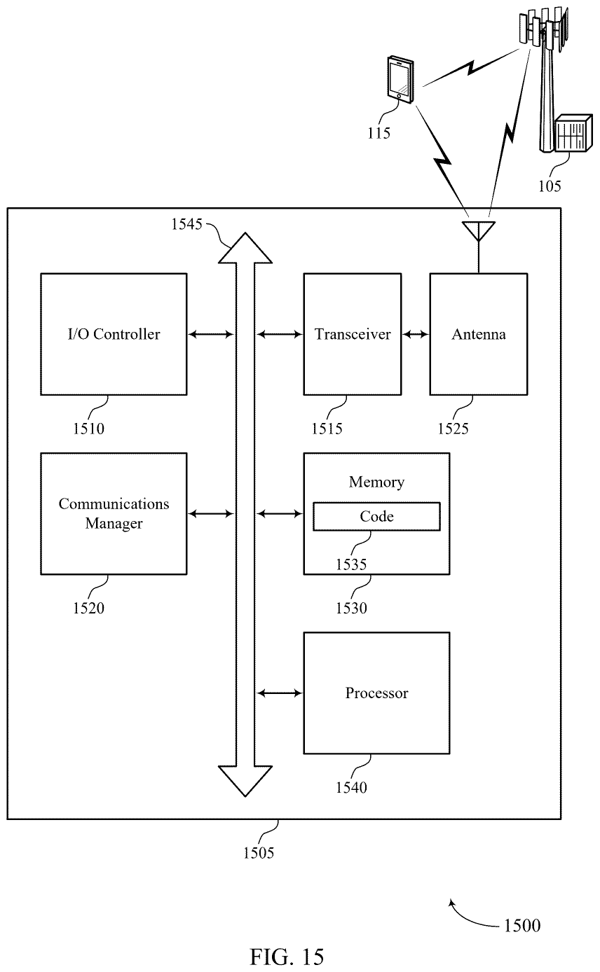

FIG. 15 shows a diagram of a system 1500 including a device 1505 that supports techniques for notifying PDU set based quality of service reports in accordance with one or more aspects of the present disclosure. The device 1505 may be an example of or include components of a device 1205, a device 1305, or a UE 115 as described herein. The device 1505 may communicate (e.g., wirelessly) with one or more other devices (e.g., network entities 105, UEs 115, or a combination thereof). The device 1505 may include components for bi-directional voice and data communications including components for transmitting and receiving communications, such as a communications manager 1520, an input/output (I/O) controller, such as an I/O controller 1510, a transceiver 1515, one or more antennas 1525, at least one memory 1530, code 1535, and at least one processor 1540. These components may be in electronic communication or otherwise coupled (e.g., operatively, communicatively, functionally, electronically, electrically) via one or more buses (e.g., a bus 1545).

The I/O controller 1510 may manage input and output signals for the device 1505. The I/O controller 1510 may also manage peripherals not integrated into the device 1505. In some cases, the I/O controller 1510 may represent a physical connection or port to an external peripheral. In some cases, the I/O controller 1510 may utilize an operating system such as iOS®, ANDROID®, MS-DOS®, MS-WINDOWS®, OS/2®, UNIX®, LINUX®, or another known operating system. Additionally, or alternatively, the I/O controller 1510 may represent or interact with a modem, a keyboard, a mouse, a touchscreen, or a similar device. In some cases, the I/O controller 1510 may be implemented as part of one or more processors, such as the at least one processor 1540. In some cases, a user may interact with the device 1505 via the I/O controller 1510 or via hardware components controlled by the I/O controller 1510.

In some cases, the device 1505 may include a single antenna. However, in some other cases, the device 1505 may have more than one antenna, which may be capable of concurrently transmitting or receiving multiple wireless transmissions. The transceiver 1515 may communicate bi-directionally via the one or more antennas 1525 using wired or wireless links as described herein. For example, the transceiver 1515 may represent a wireless transceiver and may communicate bi-directionally with another wireless transceiver. The transceiver 1515 may also include a modem to modulate the packets, to provide the modulated packets to one or more antennas 1525 for transmission, and to demodulate packets received from the one or more antennas 1525. The transceiver 1515, or the transceiver 1515 and one or more antennas 1525, may be an example of a transmitter 1215, a transmitter 1315, a receiver 1210, a receiver 1310, or any combination thereof or component thereof, as described herein.

The at least one memory 1530 may include random access memory (RAM) and read-only memory (ROM). The at least one memory 1530 may store computer-readable, computer-executable, or processor-executable code, such as the code 1535. The code 1535 may include instructions that, when executed by the at least one processor 1540, cause the device 1505 to perform various functions described herein. The code 1535 may be stored in a non-transitory computer-readable medium such as system memory or another type of memory. In some cases, the code 1535 may not be directly executable by the at least one processor 1540 but may cause a computer (e.g., when compiled and executed) to perform functions described herein. In some cases, the at least one memory 1530 may include, among other things, a basic I/O system (BIOS) which may control basic hardware or software operation such as the interaction with peripheral components or devices.

The at least one processor 1540 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1540 may be configured to operate a memory array using a memory controller. In some other cases, a memory controller may be integrated into the at least one processor 1540. The at least one processor 1540 may be configured to execute computer-readable instructions stored in a memory (e.g., the at least one memory 1530) to cause the device 1505 to perform various functions (e.g., functions or tasks supporting techniques for notifying PDU set based quality of service reports). For example, the device 1505 or a component of the device 1505 may include at least one processor 1540 and at least one memory 1530 coupled with or to the at least one processor 1540, the at least one processor 1540 and the at least one memory 1530 configured to perform various functions described herein.

In some examples, the at least one processor 1540 may include multiple processors and the at least one memory 1530 may include multiple memories. One or more of the multiple processors may be coupled with one or more of the multiple memories, which may, individually or collectively, be configured to perform various functions described herein. In some examples, the at least one processor 1540 may be a component of a processing system, which may refer to a system (such as a series) of machines, circuitry (including, for example, one or both of processor circuitry (which may include the at least one processor 1540) and memory circuitry (which may include the at least one memory 1530)), or components, that receives or obtains inputs and processes the inputs to produce, generate, or obtain a set of outputs. The processing system may be configured to perform one or more of the functions described herein. For example, the at least one processor 1540 or a processing system including the at least one processor 1540 may be configured to, configurable to, or operable to cause the device 1505 to perform one or more of the functions described herein. Further, as described herein, being “configured to,” being “configurable to,” and being “operable to” may be used interchangeably and may be associated with a capability, when executing code 1535 (e.g., processor-executable code) stored in the at least one memory 1530 or otherwise, to perform one or more of the functions described herein.

The communications manager 1520 may support wireless communications in accordance with examples as disclosed herein. For example, the communications manager 1520 is capable of, configured to, or operable to support a means for transmitting a request to receive a data traffic flow, where the data traffic flow includes one or more PDU sets and is associated with a quality of service. The communications manager 1520 is capable of, configured to, or operable to support a means for receiving the one or more PDU sets based on the quality of service being satisfied, where satisfaction of the quality of service is determined on a per PDU set basis.

By including or configuring the communications manager 1520 in accordance with examples as described herein, the device 1505 may support techniques for a UE to request for a data traffic flow and receive PDU sets of the data traffic flow based on a quality of service being satisfied on a per PDU set basis to support improved communication reliability, reduced latency, improved user experience related to reduced processing, reduced power consumption, more efficient utilization of communication resources, improved coordination between devices, longer battery life, and improved utilization of processing capability.

In some examples, the communications manager 1520 may be configured to perform various operations (e.g., receiving, monitoring, transmitting) using or otherwise in cooperation with the transceiver 1515, the one or more antennas 1525, or any combination thereof. Although the communications manager 1520 is illustrated as a separate component, in some examples, one or more functions described with reference to the communications manager 1520 may be supported by or performed by the at least one processor 1540, the at least one memory 1530, the code 1535, or any combination thereof. For example, the code 1535 may include instructions executable by the at least one processor 1540 to cause the device 1505 to perform various aspects of techniques for notifying PDU set based quality of service reports as described herein, or the at least one processor 1540 and the at least one memory 1530 may be otherwise configured to, individually or collectively, perform or support such operations.

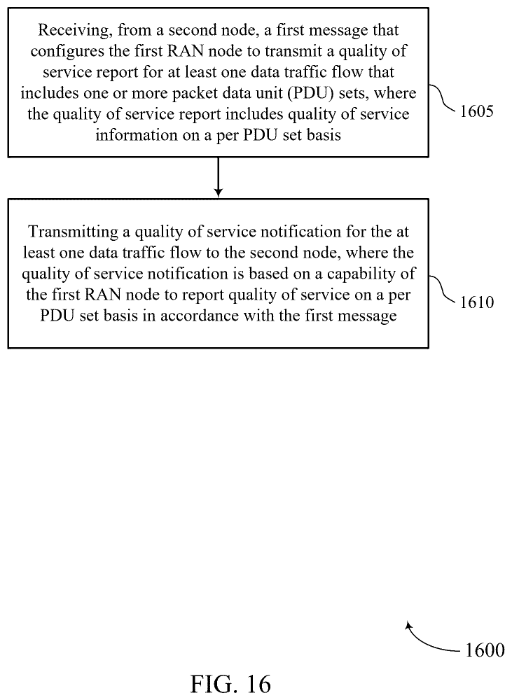

FIG. 16 shows a flowchart illustrating a method 1600 that supports techniques for notifying PDU set based quality of service reports in accordance with one or more aspects of the present disclosure. The operations of the method 1600 may be implemented by a network entity or its components as described herein. For example, the operations of the method 1600 may be performed by a network entity as described with reference to FIGS. 1 through 11. In some examples, a network entity may execute a set of instructions to control the functional elements of the network entity to perform the described functions. Additionally, or alternatively, the network entity may perform aspects of the described functions using special-purpose hardware.

At 1605, the method may include receiving, from a second node, a first message that configures the first RAN node to transmit a quality of service report for at least one data traffic flow that includes one or more PDU sets, where the quality of service report includes quality of service information on a per PDU set basis. The operations of 1605 may be performed in accordance with examples as disclosed herein. In some examples, aspects of the operations of 1605 may be performed by a quality of service report configuration receiver 1025 as described with reference to FIG. 10.

At 1610, the method may include transmitting a quality of service notification for the at least one data traffic flow to the second node, where the quality of service notification is based on a capability of the first RAN node to report quality of service on a per PDU set basis in accordance with the first message. The operations of 1610 may be performed in accordance with examples as disclosed herein. In some examples, aspects of the operations of 1610 may be performed by a quality of service notification transmitter 1030 as described with reference to FIG. 10.

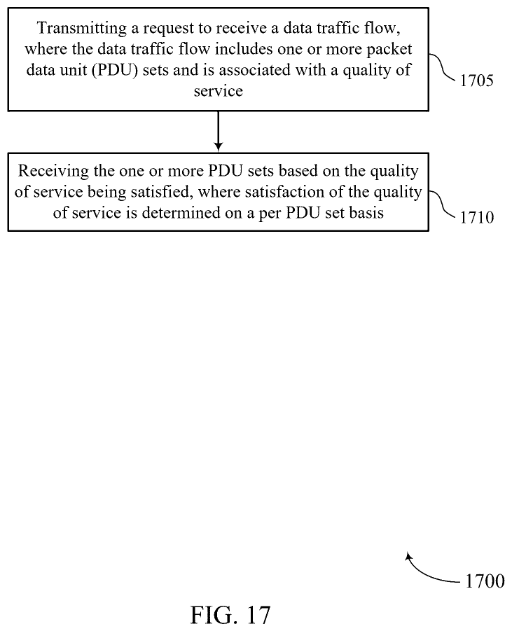

FIG. 17 shows a flowchart illustrating a method 1700 that supports techniques for notifying PDU set based quality of service reports in accordance with one or more aspects of the present disclosure. The operations of the method 1700 may be implemented by a UE or its components as described herein. For example, the operations of the method 1700 may be performed by a UE 115 as described with reference to FIGS. 1 through 7 and 12 through 15. In some examples, a UE may execute a set of instructions to control the functional elements of the UE to perform the described functions. Additionally, or alternatively, the UE may perform aspects of the described functions using special-purpose hardware.

At 1705, the method may include transmitting a request to receive a data traffic flow, where the data traffic flow includes one or more PDU sets and is associated with a quality of service. The operations of 1705 may be performed in accordance with examples as disclosed herein. In some examples, aspects of the operations of 1705 may be performed by a data traffic flow request transmitter 1425 as described with reference to FIG. 14.

At 1710, the method may include receiving the one or more PDU sets based on the quality of service being satisfied, where satisfaction of the quality of service is determined on a per PDU set basis. The operations of 1710 may be performed in accordance with examples as disclosed herein. In some examples, aspects of the operations of 1710 may be performed by a PDU set receiver 1430 as described with reference to FIG. 14.

The following provides an overview of aspects of the present disclosure:

Aspect 1: A method for wireless communications by a first RAN node, comprising: receiving, from a second node, a first message that configures the first RAN node to transmit a quality of service report for at least one data traffic flow that includes one or more PDU sets, wherein the quality of service report includes quality of service information on a per PDU set basis ; and transmitting a quality of service notification for the at least one data traffic flow to the second node, wherein the quality of service notification is based at least in part on a capability of the first RAN node to report quality of service on a per PDU set basis in accordance with the first message.

Aspect 2: The method of aspect 1, further comprising: transmitting, to the second node, an indication of the capability of the first RAN node to report the quality of service on a per PDU set basis, the indication of the capability being transmitted in response to reception of the first message.

Aspect 3: The method of aspect 2, further comprising: receiving, from the second node and in response to transmission of the indication of the capability of the first RAN node, a request to transmit the quality of service notification for the at least one data traffic flow on a per PDU set basis in accordance with the capability of the first RAN node, wherein transmission of the quality of service notification is based at least in part on reception of the request.

Aspect 4: The method of any of aspects 2 through 3, wherein the indication of the capability of the first RAN node to report the quality of service on a per PDU set basis is transmitted via an information element on an interface between the first RAN node and the second node.

Aspect 5: The method of any of aspects 1 through 4, wherein transmitting the quality of service notification comprises: transmitting the quality of service notification to the second node in response to reception of the first message, wherein transmission of the quality of service notification is based at least in part on the capability of the first RAN node.

Aspect 6: The method of any of aspects 1 through 5, wherein the second node is an access and mobility function, and the method further comprises: receiving, from the second node, the first message via one or more first messages on an interface between the first RAN node and the second node; and transmitting, to the second node, an indication of the capability of the first RAN node via one or more second messages on the interface between the first RAN node and the second node.

Aspect 7: The method of aspect 6, further comprising: receiving, from the second node, an indication of one or more additional quality of service parameters that are associated with PDU sets via the one or more first messages on the interface between the first RAN node and the second node.

Aspect 8: The method of aspect 7, wherein the one or more first messages comprise a PDU session resource setup request message, a PDU session modification request message, a path switch request acknowledgment message, or any combination thereof, and the one or more second messages comprise a PDU session resource setup response message, a PDU session modification response message, a path switch request message, or any combination thereof.

Aspect 9: The method of any of aspects 6 through 8, wherein the first message is associated with the at least one data traffic flow and the indication of the capability of the first RAN node is associated with a quality of service flow associated with the at least one data traffic flow, a PDU session, or both.

Aspect 10: The method of any of aspects 1 through 9, wherein the first RAN node is a distributed unit of a first network entity and the second node is a centralized unit of the first network entity, and the method further comprises: receiving, from the second node, the first message via one or more first messages on an interface between the first RAN node and the second node; and transmitting, to the second node, an indication of the capability of the first RAN node via one or more second messages on the interface between the first RAN node and the second node.

Aspect 11: The method of aspect 10, further comprising: receiving, from the second node, an indication of one or more additional quality of service parameters that are associated with PDU sets via the one or more first messages on the interface between the first RAN node and the second node.

Aspect 12: The method of aspect 11, wherein the one or more first messages comprise a context setup request message, a context modification message, or a combination thereof, and the one or more second messages comprise a context setup response message, a context modification response message, or a combination thereof.

Aspect 13: The method of any of aspects 10 through 12 wherein the first message is associated with a quality of service flow associated with the at least one data traffic flow and the indication of the capability of the first RAN node is associated with a UE context.

Aspect 14: The method of any of aspects 1 through 13, wherein the first RAN node is a first network entity and the second node is a second network entity, and the method further comprises: receiving, from the second node, the first message via one or more first messages on an interface between the first RAN node and the second node; and transmitting, to the second node, an indication of the capability of the first RAN node via one or more second messages on the interface between the first RAN node and the second node.

Aspect 15: The method of aspect 14, further comprising: receiving, from the second node, an indication of one or more additional quality of service parameters that are associated with PDU sets via the one or more first messages on the interface between the first RAN node and the second node.

Aspect 16: The method of aspect 15, wherein the one or more first messages comprise a handover request message, an addition request message, a modification request message, or a combination thereof, and the one or more second messages comprise an addition request acknowledge message, a modification request acknowledge message, or a combination thereof.

Aspect 17: The method of any of aspects 1 through 16, wherein the first RAN node is a centralized unit of a first network entity that is associated with a user plane and the second node is the centralized unit of the first network entity that is associated with a control plane, and the method further comprises: receiving, from the second node, an indication of one or more additional quality of service parameters that are associated with PDU sets via one or more first messages on an interface between the first RAN node and the second node.

Aspect 18: The method of aspect 17, wherein the one or more first messages comprise a bearer context setup request message, a bearer context modification request message, or a combination thereof.

Aspect 19: The method of any of aspects 1 through 18, wherein the first message is transmitted via an information element on an interface between the first RAN node and the second node and a presence of the information element indicates a request for the quality of service notification that is on a PDU set basis.

Aspect 20: The method of any of aspects 1 through 19, further comprising: receiving, from the second node, an indication of one or more additional quality of service parameters that are associated with PDU sets via an information element on an interface between the first RAN node and the second node.

Aspect 21: The method of aspect 20, wherein the one or more additional quality of service parameters comprises a PDU set packet delay budget parameter, a PDU set error rate, or both.

Aspect 22: The method of any of aspects 20 through 21, wherein the indication of the one or more additional quality of service parameters associated with PDU sets are indicated via a set of indexes associated with one or more quality of service parameters that are associated with PDUs of PDU sets.

Aspect 23: The method of any of aspects 20 through 22, wherein an indication of one or more quality of service parameters associated with PDUs of PDU sets are indicated via a first subset of indexes of a set of indexes and the indication of the one or more additional quality of service parameters associated with PDU sets are indicated via a second subset of indexes of the set of indexes that is subsequent to the first subset of indexes.

Aspect 24: The method of any of aspects 20 through 23, wherein an indication of one or more quality of service parameters associated with PDUs of PDU sets are indicated via a first set of indexes and the indication of the one or more additional quality of service parameters associated with PDU sets are indicated via a second set of indexes that is different from the first set of indexes.

Aspect 25: A method for wireless communications by a first UE comprising: transmitting a request to receive a data traffic flow, wherein the data traffic flow includes one or more PDU sets and is associated with a quality of service; and receiving the one or more PDU sets based at least in part on the quality of service being satisfied, wherein satisfaction of the quality of service is determined on a per PDU set basis.

Aspect 26: The method of aspect 25, wherein satisfaction of the quality of service is based on satisfaction of one or more PDU set quality of service parameters.

Aspect 27: The method of aspect 26, wherein the one or more PDU set quality of service parameters include a PDU set delay budget parameter, a PDU set error rate parameter, a PDU set integrated handling information indicator, or any combination thereof.

Aspect 28: The method of aspect 27, wherein satisfaction of the quality of service is based at least in part on one or more thresholds being satisfied based on the one or more PDU set quality of service parameters.

Aspect 29: The method of aspect 28, wherein the one or more thresholds include a guaranteed bit rate threshold, a guaranteed flow bit rate threshold, a PDU set delay budget threshold, a PDU set error rate threshold, or any combination thereof.

Aspect 30: A first RAN node for wireless communications, comprising one or more memories storing processor-executable code, and one or more processors coupled with the one or more memories and individually or collectively operable to execute the code to cause the first RAN node to perform a method of any of aspects 1 through 24.

Aspect 31: A first RAN node for wireless communications, comprising at least one means for performing a method of any of aspects 1 through 24.

Aspect 32: A non-transitory computer-readable medium storing code for wireless communications, the code comprising instructions executable by one or more processors to perform a method of any of aspects 1 through 24.

Aspect 33: A first UE for wireless communications, comprising one or more memories storing processor-executable code, and one or more processors coupled with the one or more memories and individually or collectively operable to execute the code to cause the first UE to perform a method of any of aspects 25 through 29.

Aspect 34: A first UE for wireless communications, comprising at least one means for performing a method of any of aspects 25 through 29.

Aspect 35: A non-transitory computer-readable medium storing code for wireless communications, the code comprising instructions executable by one or more processors to perform a method of any of aspects 25 through 29.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A first radio access network (RAN) node, comprising:
one or more memories storing processor-executable code; and
one or more processors coupled with the one or more memories and individually or collectively operable to execute the code to cause the first RAN node to:
receive, from a second node, a first message that configures the first RAN node to transmit a quality of service report for at least one data traffic flow that includes one or more packet data unit (PDU) sets, wherein the quality of service report includes quality of service information on a per PDU set basis; and
transmit a quality of service notification for the at least one data traffic flow to the second node, wherein the quality of service notification is based at least in part on a capability of the first RAN node to report quality of service on a per PDU set basis in accordance with the first message.

2. The first RAN node of claim 1, wherein the one or more processors are individually or collectively further operable to execute the code to cause the RAN node to:
transmit, to the second node, an indication of the capability of the first RAN node to report the quality of service on a per PDU set basis, the indication of the capability being transmitted in response to reception of the first message.

3. The first RAN node of claim 2, wherein the one or more processors are individually or collectively further operable to execute the code to cause the first RAN node to:
receive, from the second node and in response to transmission of the indication of the capability of the first RAN node, a request to transmit the quality of service notification for the at least one data traffic flow on a per PDU set basis in accordance with the capability of the first RAN node, wherein transmission of the quality of service notification is based at least in part on reception of the request.

4. The first RAN node of claim 1, wherein, to transmit the quality of service notification, the one or more processors are individually or collectively operable to execute the code to cause the first RAN node to:
transmit the quality of service notification to the second node in response to reception of the first message, wherein transmission of the quality of service notification is based at least in part on the capability of the first RAN node.

5. The first RAN node of claim 1, wherein the second node is an access and mobility function, and the one or more processors are individually or collectively further operable to execute the code to cause the first RAN node to:
receive, from the second node, the first message via one or more first messages on an interface between the first RAN node and the second node; and
transmit, to the second node, an indication of the capability of the first RAN node via one or more second messages on the interface between the first RAN node and the second node.

6. The first RAN node of claim 5, wherein the one or more processors are individually or collectively further operable to execute the code to cause the first RAN node to:
receive, from the second node, an indication of one or more additional quality of service parameters that are associated with PDU sets via the one or more first messages on the interface between the first RAN node and the second node.

7. The first RAN node of claim 1, wherein the first RAN node is a distributed unit of a first network entity and the second node is a centralized unit of the first network entity, and the one or more processors are individually or collectively further operable to execute the code to cause the first RAN node to:
receive, from the second node, the first message via one or more first messages on an interface between the first RAN node and the second node; and
transmit, to the second node, an indication of the capability of the first RAN node via one or more second messages on the interface between the first RAN node and the second node.

8. The first RAN node of claim 7, wherein the one or more processors are individually or collectively further operable to execute the code to cause the first RAN node to:
receive, from the second node, an indication of one or more additional quality of service parameters that are associated with PDU sets via the one or more first messages on the interface between the first RAN node and the second node.

9. The first RAN node of claim 1, wherein the first RAN node is a first network entity and the second node is a second network entity, and the one or more processors are individually or collectively further operable to execute the code to cause the first RAN node to:
receive, from the second node, the first message via one or more first messages on an interface between the first RAN node and the second node; and
transmit, to the second node, an indication of the capability of the first RAN node via one or more second messages on the interface between the first RAN node and the second node.

10. The first RAN node of claim 9, wherein the one or more processors are individually or collectively further operable to execute the code to cause the first RAN node to:
receive, from the second node, an indication of one or more additional quality of service parameters that are associated with PDU sets via the one or more first messages on the interface between the first RAN node and the second node.

11. The first RAN node of claim 1, wherein the first RAN node is a centralized unit of a first network entity that is associated with a user plane and the second node is the centralized unit of the first network entity that is associated with a control plane, and the one or more processors are individually or collectively further operable to execute the code to cause the first radio access network (RAN) node to:
receive, from the second node, an indication of one or more additional quality of service parameters that are associated with PDU sets via one or more first messages on an interface between the first RAN node and the second node.

12. The first RAN node of claim 1, wherein the one or more processors are individually or collectively further operable to execute the code to cause the first RAN node to:
receive, from the second node, an indication of one or more additional quality of service parameters that are associated with PDU sets via an information element on an interface between the first RAN node and the second node.

13. The first RAN node of claim 12, wherein an indication of one or more quality of service parameters associated with PDUs of PDU sets are indicated via a first subset of indexes of a set of indexes and the indication of the one or more additional quality of service parameters associated with PDU sets are indicated via a second subset of indexes of the set of indexes that is subsequent to the first subset of indexes.

14. The first RAN node of claim 12, wherein an indication of one or more quality of service parameters associated with PDUs of PDU sets are indicated via a first set of indexes and the indication of the one or more additional quality of service parameters associated with PDU sets are indicated via a second set of indexes that is different from the first set of indexes.

15. A first user equipment (UE), comprising:
one or more memories storing processor-executable code; and
one or more processors coupled with the one or more memories and individually or collectively operable to execute the code to cause the first UE to:
transmit a request to receive a data traffic flow, wherein the data traffic flow includes one or more packet data unit (PDU) sets and is associated with a quality of service; and
receive the one or more PDU sets based at least in part on the quality of service being satisfied, wherein satisfaction of the quality of service is determined on a per PDU set basis.

16. The first UE of claim 15, wherein satisfaction of the quality of service is based on satisfaction of one or more PDU set quality of service parameters.

17. The first UE of claim 16, wherein the one or more PDU set quality of service parameters include a PDU set delay budget parameter, a PDU set error rate parameter, a PDU set integrated handling information indicator, or any combination thereof.

18. The first UE of claim 17, wherein satisfaction of the quality of service is based at least in part on one or more thresholds being satisfied based on the one or more PDU set quality of service parameters.

19. The first UE of claim 18, wherein the one or more thresholds include a guaranteed bit rate threshold, a guaranteed flow bit rate threshold, a PDU set delay budget threshold, a PDU set error rate threshold, or any combination thereof.

20. A method for wireless communications by a first radio access network (RAN) node, comprising:
receiving, from a second node, a first message that configures the first RAN node to transmit a quality of service report for at least one data traffic flow that includes one or more packet data unit (PDU) sets, wherein the quality of service report includes quality of service information on a per PDU set basis; and
transmitting a quality of service notification for the at least one data traffic flow to the second node, wherein the quality of service notification is based at least in part on a capability of the first RAN node to report quality of service on a per PDU set basis in accordance with the first message.
